(19) United States
(12) Patent Application Publication
(10) Pub. No.: US 2025/0232651 A1
(43) Pub. Date: Jul. 17, 2025

(54) DATA PROCESSING FOR HAPTIC MEDIA

(71) Applicant: Tencent Technology (Shenzhen) Company Limited, Shenzhen (CN)

(72) Inventor: Ying HU, Shenzhen (CN)

(73) Assignee: Tencent Technology (Shenzhen) Company Limited, Shenzhen (CN)

(21) Appl. No.: 19/098,890

(22) Filed: Apr. 2, 2025

Related U.S. Application Data
(63) Continuation of application No. PCT/CN2023/126332, filed on Oct. 25, 2023.

(30) Foreign Application Priority Data
Jan. 9, 2023 (CN) 202310027189.2

(51) Int. Cl. G08B 6/00

(52) U.S. Cl. CPC G08B 6/00

(57) ABSTRACT

Some aspects of the disclosure provide a method of data processing. In some examples, a media file of haptic media is obtained. The media file includes a first portion that is a bitstream of media data of the haptic media and a second portion that is relationship indication information indicating an association relationship between the haptic media and at least a non-haptic media. Also, the bitstream is decoded according to the relationship indication information to obtain the media data for presenting the haptic media. Apparatus and non-transitory computer-readable storage medium counterpart embodiments are also contemplated.

### RELATED APPLICATIONS

The present application is a continuation of International Application No. PCT/CN2023/126332, filed on Oct. 25, 2023, which claims priority to Chinese Patent Application No. 202310027189.2, filed on Jan. 9, 2023. The entire disclosures of the prior applications are hereby incorporated by reference.

### FIELD OF THE TECHNOLOGY

This disclosure relates to the field of audio and video technologies, and specifically, to a data processing method for haptic media, a data processing apparatus for haptic media, a computer device, a computer-readable storage medium, and a computer program product.

### BACKGROUND OF THE DISCLOSURE

With continuous development of immersive media, in addition to visual and auditory presentation, presentation manners of immersive media further include new haptic presentation manners, for example, vibration haptics and electric haptics. It is found in practice that currently, encoding and decoding technologies for haptic media have some technical problems that urgently need to be resolved. For example, presentation of the haptic media may be associated with presentation of media of other media type (for example, audio media and video media). For example, vibration is triggered while audio is played. In this case, there is a technical problem that current encoding and decoding technologies for haptic media cannot correctly present the haptic media, leading to a relatively poor presentation effect of the haptic media.

### SUMMARY

Embodiments of this disclosure provide a data processing method for haptic media and a related device, to improve presentation accuracy of the haptic media and improve a presentation effect of the haptic media.

Some aspects of the disclosure provide a method of data processing. In some examples, a media file of haptic media is obtained. The media file includes a first portion that is a bitstream of media data of the haptic media and a second portion that is relationship indication information indicating an association relationship between the haptic media and at least a non-haptic media. Also, the bitstream is decoded according to the relationship indication information to obtain the media data for presenting the haptic media.

Some aspects of the disclosure provide an information processing apparatus that includes processing circuitry. In an example, the processing circuitry obtains a media file of haptic media, the media file includes a first portion that is a bitstream of media data of the haptic media and a second portion that is relationship indication information indicating an association relationship between the haptic media and at least a non-haptic media. The processing circuitry decodes the bitstream according to the relationship indication information to obtain the media data for presenting the haptic media.

According to an aspect, the embodiments of this disclosure provide a data processing method for haptic media, performed by a consumption device and including:

obtaining a media file of haptic media, the media file including a bitstream and relationship indication information of the haptic media, the relationship indication information being configured for indicating an association relationship between the haptic media and other media, and the other media including media whose media type is a non-haptic type; and

decoding the bitstream according to the relationship indication information, to present the haptic media.

According to an aspect, the embodiments of this disclosure provide a data processing method for haptic media, performed by a service device and including:

encoding haptic media, to obtain a bitstream of the haptic media;

determining an association relationship between the haptic media and other media according to a presentation condition of the haptic media, the other media including media whose media type is a non-haptic type;

generating relationship indication information based on the association relationship between the haptic media and the other media; and

encapsulating the relationship indication information and the bitstream, to obtain a media file of the haptic media.

According to an aspect, the embodiments of this disclosure provide a data processing apparatus for haptic media, including:

an obtaining unit, configured to obtain a media file of haptic media, the media file including a bitstream and relationship indication information of the haptic media, the relationship indication information being configured for indicating an association relationship between the haptic media and other media, and the other media including media whose media type is a non-haptic type; and

a processing unit, configured to decode the bitstream according to the relationship indication information, to present the haptic media.

According to an aspect, the embodiments of this disclosure provide a data processing apparatus for haptic media, including:

an encoding unit, configured to encode haptic media, to obtain a bitstream of the haptic media; and

a processing unit, configured to determine an association relationship between the haptic media and other media according to a presentation condition of the haptic media, the other media including media whose media type is a non-haptic type;

the processing unit being further configured to generate relationship indication information based on the association relationship between the haptic media and the other media; and

the processing unit being further configured to encapsulate the relationship indication information and the bitstream, to obtain a media file of the haptic media.

According to an aspect, the embodiments of this disclosure provide a computer device, including:

a processor (an example of processing circuitry), configured to execute a computer program; and

a computer-readable storage medium, having a computer program stored therein, when the computer program is executed by the processor, the foregoing data processing method for haptic media being implemented.

According to an aspect, the embodiments of this disclosure provide a computer-readable storage medium, having a computer program stored therein, when the computer program is loaded and executed by a processor, the foregoing data processing method for haptic media being implemented.

According to an aspect, the embodiments of this disclosure provide a computer program product, including a computer program or a computer instruction, the computer program or the computer instruction being stored in a computer-readable storage medium (for example, non-transitory computer-readable storage medium), and a processor of a computer device reading and executing the computer program or the computer instruction from the computer-readable storage medium, to enable the computer device to perform the foregoing data processing method for haptic media.

In the embodiments of this disclosure, a decoder side (a consumption device) of the haptic media may obtain the media file of the haptic media, the media file including a bitstream and relationship indication information of the haptic media, and the relationship indication information being configured for indicating an association relationship between the haptic media and other media (including media whose media type is a non-haptic type), and decode the bitstream according to the relationship indication information, to present the haptic media. As can be known from the foregoing solutions, in the embodiments of this disclosure, an encoder side (a service device) may add the relationship indication information to the media file of the haptic media in the process of encoding the haptic media. In this way, the decoder side (the consumption device) can be effectively guided to accurately present the haptic media based on the association relationship between the haptic media and the other media indicated by the relationship indication information, thereby improving presentation accuracy of the haptic media and improving a presentation effect of the haptic media.

### BRIEF DESCRIPTION OF THE DRAWINGS

FIG. 1a is a schematic diagram of 6DoF according to an exemplary embodiment of this disclosure;

FIG. 1b is a schematic diagram of 3DoF according to an exemplary embodiment of this disclosure;

FIG. 1c is a schematic diagram of 3DoF+ according to an exemplary embodiment of this disclosure;

FIG. 2a is an architectural diagram of a data processing system for haptic media according to an exemplary embodiment of this disclosure;

FIG. 2b is a flowchart of data processing for haptic media according to an exemplary embodiment of this disclosure;

FIG. 3 is a schematic flowchart of a data processing method for haptic media according to an exemplary embodiment of this disclosure;

FIG. 4a is a schematic diagram of a sphere region according to an exemplary embodiment of this disclosure;

FIG. 4b is a schematic diagram of a sphere region according to another exemplary embodiment of this disclosure;

FIG. 5 is a schematic flowchart of a data processing method for haptic media according to another exemplary embodiment of this disclosure;

FIG. 6 is a schematic structural diagram of a data processing apparatus for haptic media according to an exemplary embodiment of this disclosure;

FIG. 7 is a schematic structural diagram of a data processing apparatus for haptic media according to another exemplary embodiment of this disclosure; and

FIG. 8 is a schematic structural diagram of a computer device according to an exemplary embodiment of this disclosure.

### DESCRIPTION OF EMBODIMENTS

Examples of terms involved in the aspects of the disclosure are briefly introduced. The descriptions of the terms are provided as examples only and are not intended to limit the scope of the disclosure.

In this disclosure, the terms “first”, “second”, and the like are used for distinguishing between same items or similar items that have basically same effects and functions. “First”, “second”, and “n^{th}” do not have logical or time sequence dependency, and a number and an execution sequence are not limited either. In this disclosure, the term “at least one” means one or more, and “a plurality of” means two or more. For example: that haptic media includes a plurality of haptic signals means that the haptic media includes two or more haptic signals.

### 1. Immersive Media

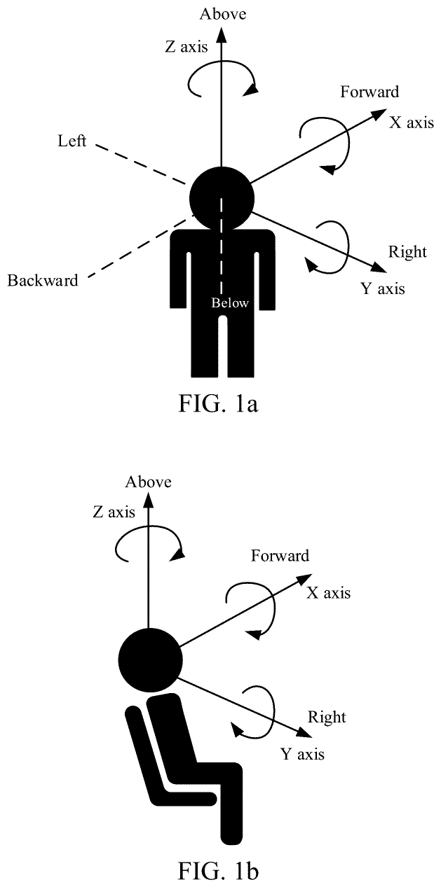

Immersive media is a media file that can provide immersive media content, so that a consumer immersed in the media content can obtain visual experience, auditory experience, haptic experience, or other sensory experience in the real world. Immersive media may include, but is not limited to, at least one of the following: audio media, video media, haptic media, and the like. Audio media is a media form in which information is transmitted and expressed by using sound, has features such as a high transmission speed, being easy to digest, and being suitable for multitask processing, and can satisfy requirements of consumers for obtaining information and entertainment in different scenarios. Audio media in the embodiments of this disclosure is immersive media whose media type is an auditory type, and is a media file that can provide auditory sensory experience in the real world for consumers. Video media is a media form in which information is transmitted and expressed by using a combination of images and sound, has features such as strong visual impact, abundant expressiveness, and being capable of conveying sentiments and stories, and can satisfy requirements of consumers for visual and auditory stimulation. Video media in the embodiments of this disclosure is immersive media whose media type is a visual type, and is a media file that can provide visual and auditory sensory experience in the real world for consumers. Haptic media is a media form in which information is transmitted and a sense is stimulated by means of touch, and enables consumers to sense and experience different haptic stimulations including touch, vibration, pressure, and the like by simulating a sense of touch. Haptic media in the embodiments of this disclosure is immersive media whose media type is a haptic type, and is a media file that can provide haptic sensory experience in the real world for consumers. Consumers may include, but are not limited to, at least one of the following: listeners of audio media, viewers of video media, users of haptic media, and the like. According to degrees of freedom (DoF) of consumers when consuming media content, immersive media may be classified into: 6DoF immersive media, 3DoF immersive media, and 3DoF+ immersive media. As shown in FIG. 1a, 6DoF means that a consumer of the immersive media may freely translate along an X axis, a Y axis, and a Z axis. For example, a consumer of the immersive media may freely walk in three-dimensional 360-degree VR content. Similar to 6DoF, there are also 3DoF and 3DoF+ manufacturing technologies. FIG. 1b is a schematic diagram of 3DoF according to an embodiment of this disclosure. As shown in FIG. 1b, 3DoF means that a consumer of immersive media is fixed at the central point of a three-dimensional space, and the head of the consumer of the immersive media rotates along an X axis, a Y axis, and a Z axis to view images provided by the media content. FIG. 1c is a schematic diagram of 3DoF+ according to an embodiment of this disclosure. As shown in FIG. 1c, 3DoF+ means that when a virtual scene provided by immersive media has depth information to some extent, the head of a consumer of the immersive media may move in a limited space based on 3DoF to view images provided by the media content.

### 2. Haptics

Immersive media content is usually presented by using various intelligent devices, such as a wearable device or an interactive device. A wearable device is an electronic device that can be worn on the body of a user, and usually is in contact with the body of the user and collects, processes, and transmits data. These devices usually have small and light designs, and may be worn on parts such as wrists, heads, glasses, and clothes. Wearable devices usually include abundant types, and include, but are not limited to, smart watches, smart glasses, smart earphones, smart bracelets, smart clothes, and the like. An interactive device is a device capable of performing real-time interaction and feedback with a user. Common interactive devices may include, but are not limited to, a touchscreen, a keyboard, a mouse, a gesture recognition device, a voice recognition device, and the like. By using these devices, users may interact with devices in manners such as touching, clicking, sliding, and voice instructions, to implement various functions and operations. Therefore, in addition to visual and auditory presentation, presentation manners of immersive media further include a new haptic presentation manner. Haptics uses a haptic presentation mechanism combining hardware and software to allow a consumer to receive information through the body of the consumer, provides an embedded physical feeling, and transfers key information about a system being used by the consumer. For example, a device vibrates to remind a consumer that a piece of information has been received. Such vibration is a haptic presentation manner. Haptics may further enhance auditory and visual presentation, thereby improving consumer experience.

Haptics may include, but is not limited to, one or more of the following: vibration haptics, kinematic haptics, and electric haptics. Vibration haptics refers to simulating vibration of a specific frequency and intensity by means of vibration of a motor of a device. For example, in a shooting game, a particular effect of using a shooting tool is simulated by means of vibration. Kinematic haptics refers to simulating a weight or a pressure of an object by a kinematic haptics system, and the kinematic haptics may include but is not limited to: speed and acceleration. For example, in a driving game, when a relatively heavy vehicle is moved or operated at a relatively high speed, a steering wheel may resist rotation. This type of feedback directly affects the consumer. In the example of a driving game, the consumer needs to apply more force to obtain a needed response from the steering wheel. Electric haptics uses electric pulses to provide haptic stimulation to nerve endings of consumers. The electric haptics can create highly real experience for a consumer wearing a suit or a glove provided with an electric haptics technology. Almost any sense can be simulated by using an electric pulse: a temperature change, a pressure change, and a sense of humidity. With the popularization of wearable devices and interactive devices, the sense of touch sensed by a consumer when consuming immersive media content may include complete physical senses such as vibration, pressure, speed, acceleration, temperature, humidity, and smell, which is more approximate to real-world haptic presentation experience.

### 3. Haptic Media and Other Media

Haptic media is immersive media whose media type is a haptic type, and is a media file that can provide haptic sensory experience in the real world for consumers. The haptic media may include one or more haptic signals. The haptic signal is used for representing haptic experience, and can render a presented signal. The haptic signal may include but is not limited to: a vibration haptic signal, a pressure haptic signal, a speed haptic signal, a temperature haptic signal, and the like. In the embodiments of this disclosure, the haptic media may include time-sequence haptic media and/or non-time-sequence haptic media. There is a time sequence between haptic signals in the time-sequence haptic media. There is no time sequence between haptic signals in the non-time-sequence haptic media. According to different haptic signals, haptic types of the haptic media are also different. For example: the haptic signal is a vibration haptic signal, and a haptic type of the haptic media is vibration haptic media. For another example: the haptic signal is an electric haptic signal, and a haptic type of the haptic media is electric haptic media.

Other media is media of a different media type from that of the haptic media. That is, the other media includes media whose media type is a non-haptic type. In the embodiments of this disclosure, the other media may include, but is not limited to: two-dimensional video media, audio media, volumetric video media, multi-viewing-angle video media, subtitle media, and volumetric media. Volumetric media is media having three-dimensional content. For example, the volumetric media may be point cloud media. Two-dimensional video media is a media file that presents media content in a form of a two-dimensional image. Volumetric video media simultaneously captures images from different angles by using a plurality of cameras, and combines the images together to form a panoramic and stereoscopic video image. Volumetric video media can enable a consumer to freely select different viewing angles when watching a video, thereby obtaining immersive and interactive watching experience. Multi-viewing-angle video media simultaneously captures the same scene by using a plurality of cameras, captures images from different angles and positions, and combines the images together to form a continuous video. Different from the volumetric video media, during watching of the multi-viewing-angle video media, a consumer cannot freely select a viewing angle, and instead different viewing angles are presented by means of clipping and switching. Subtitle media is a media file formed by adding text subtitles to a video or an audio. The subtitle media enables a consumer to understand video or audio content more conveniently. Volumetric media is an emerging media form, and presents content in a three-dimensional space, so that a consumer can freely move and interact in a virtual environment. In the embodiments of this disclosure, a relationship between the haptic media and other media may include the following several cases: \textcircled{1} Haptic media has no association relationship with other media, that is, the haptic media can be independently presented without depending on other media. \textcircled{2} Haptic media has an association relationship with other media, and the association relationship may include a dependency relationship. The dependency relationship refers to: the haptic media needs to depend on other media during presentation. For example: the vibration haptic media can only be presented (that is, output vibration) based on the presentation of the two-dimensional video media. In this case, the vibration haptic media depends on the two-dimensional video media during presentation. \textcircled{3} Haptic media has an association relationship with other media, and the association relationship includes a dependency relationship, and further includes a simultaneous presentation relationship and/or a condition trigger relationship. The simultaneous presentation relationship refers to: during presentation, the haptic media needs to be simultaneously presented with other media on which the haptic media depends. For example: electric haptic media has a dependency relationship and a simultaneous presentation relationship with audio media. In this case, the electric haptic media needs to be outputted while media content of the audio media is played. The condition trigger relationship refers to: haptic media needs to be presented only when triggered by a trigger condition. For example: kinematic haptic media has a dependency relationship and a condition trigger relationship with driving game video media. The condition trigger relationship indicates a trigger condition, and the trigger condition is an event of accelerating to a speed threshold. When a driving speed of a consumer increases to the speed threshold, presentation of the kinematic haptic media is triggered (for example, a steering wheel generates a resistance movement).

In the embodiments of this disclosure, information (for example, a media type, an encapsulation position, an identifier, and a media resource) about other media on which the haptic media depends during presentation may be collectively referred to as dependency information on which the haptic media depends during presentation.

### 4. Track

A track is a media data set in an encapsulation process of a media file, and one track includes a plurality of samples having a time sequence. One media file may include one or more tracks. Illustratively, for example, one video media file may include but is not limited to: a video media track, an audio media track, and a subtitle media track. Particularly, metadata information may also be used as a media type and included in a media file in the form of a metadata track. The metadata information is a collective name of information related to presentation of the haptic media. Metadata may include description information of media content of the haptic media, dependency information on which the haptic media depends, signaling information related to presentation of the media content of the haptic media, and the like. In the embodiments of this disclosure, time-sequence haptic media is included in the media file of the haptic media in a form of a haptic media track.

### 5. Sample

A sample is an encapsulation unit in an encapsulation process of a media file. One track includes many samples, for example, one video media track may include many samples, and a sample is usually a video frame. In this embodiment of this disclosure, as described above, the time-sequence haptic media may be included in the media file of the haptic media in the form of a haptic media track. The haptic media track includes one or more samples, and each sample may include one or more haptic signals in the time-sequence haptic media.

### 6. Sample Entry

A sample entry is used for indicating metadata information related to all samples in a track. For example: a sample entry of a video media track usually includes metadata information related to initialization of a consumption device. For another example: the sample entry of the haptic media track usually includes a decoder configuration record.

### 7. Item

An item is an encapsulation unit of non-time-sequence media data in an encapsulation process of a media file. For example: one static image may be encapsulated as one item. In this embodiment of this disclosure, the non-time-sequence haptic media may be encapsulated as one or more items.

### 8. ISO Based Media File Format (ISOBMFF)

The ISOBMFF is an encapsulation standard for a media file, and a typical ISOBMFF file is an MP4 file.

### 9. Dynamic Adaptive Streaming Over HTTP (DASH).

The DASH is an adaptive bitrate technology that enables high-quality streaming media to be transferred over the Internet by using a HTTP network server.

### 10. Media Presentation Description (MPD).

MPD is media presentation description signaling in DASH and is used for describing media segment information in the media file.

### 11. Representation

Representation refers to a combination of one or more media components in DASH. The media component refers to an element or a component that forms media, for example, a text, an image, an audio, or a video. For example, a video file of a specific resolution may be considered as a representation. For example: a video file of a time domain level may be considered as a representation.

### 12. Adaption Set.

An adaption set is a set of one or more video streams in DASH. One adaption set may include a plurality of representations. A video stream refers to continuous video data transmitted through a network.

This disclosure provides a data processing solution for haptic media. The solution is divided into a processing procedure at an encoder side of the haptic media and a processing procedure at a decoder side of the haptic media. This specifically includes:

(1) The processing procedure at an encoder side is approximately as follows:

\textcircled{1} obtaining haptic media and encoding the haptic media, to obtain a bitstream of the haptic media; \textcircled{2} obtaining a presentation condition of the haptic media, and determining an association relationship between the haptic media and other media based on the presentation condition, where the other media may include media whose media type is a non-haptic type, and the non-haptic media may include, but is not limited to, two-dimensional video media, audio media, volumetric video media, multi-viewing-angle video media, and subtitle media; and \textcircled{3} generating relationship indication information based on the association relationship between the haptic media and the other media, and encapsulating the relationship indication information and the bitstream, to obtain a media file of the haptic media.

(2) The processing procedure at a decoder side is approximately as follows:

\textcircled{1} obtaining a media file of haptic media, the media file including a bitstream and relationship indication information of the haptic media, and the relationship indication information being configured for indicating an association relationship between the haptic media and other media, and
\textcircled{2} decoding the haptic media and the other media according to the relationship indication information in the media file, and presenting the decoded haptic media and other media according to the relationship indication information.

As can be known from the foregoing solutions, in the embodiments of this disclosure, on the one hand, the encoder side may add the relationship indication information to the media file of the haptic media in the process of encoding the haptic media. In this way, the decoder side can be effectively guided to accurately present the haptic media based on the association relationship between the haptic media and the other media indicated by the relationship indication information. On the other hand, the decoder side may parse the media file of the haptic media to obtain the relationship indication information, and decode the haptic media and the other media as indicated by the relationship indication information, thereby improving presentation accuracy of the haptic media and improving a presentation effect of the haptic media.

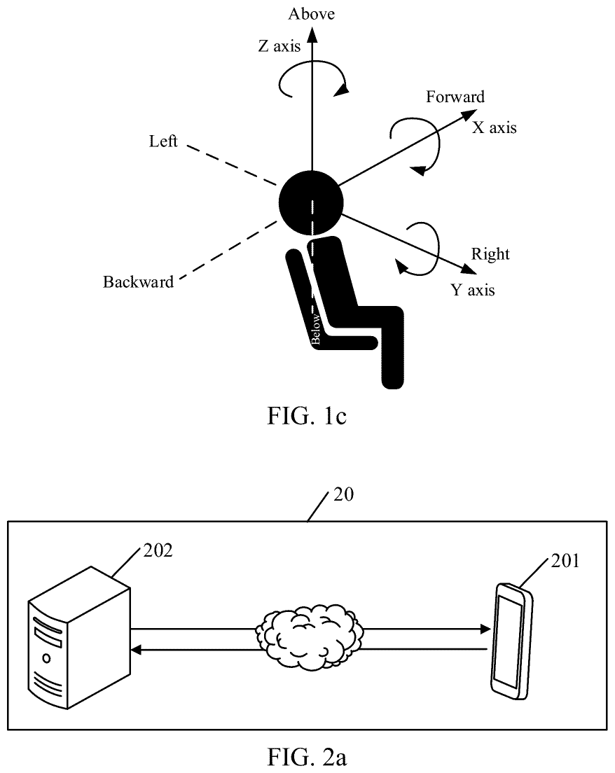

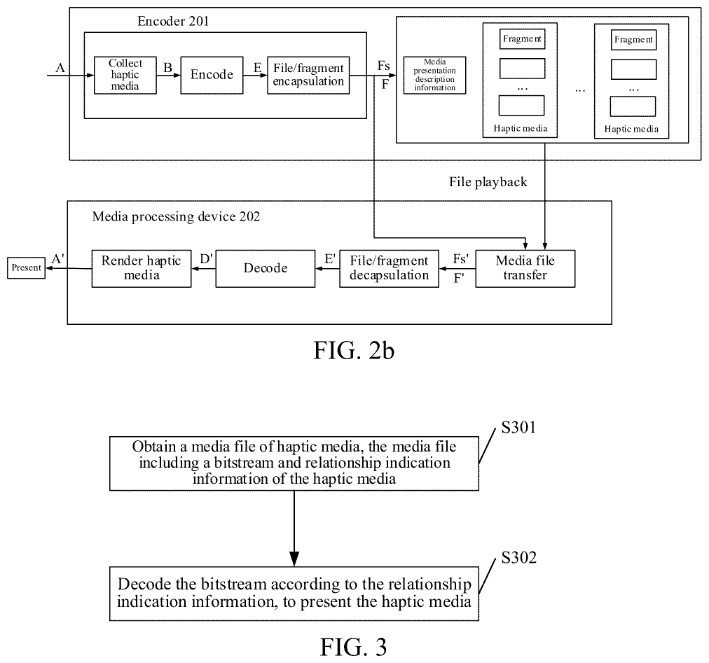

Based on the above description, a data processing system for haptic media provided by the embodiments of this disclosure is introduced below with reference to FIG. 2a. As shown in FIG. 2a, a data processing system 20 for haptic media may include a service device 201 and a consumption device 202. The service device 201 may be used as an encoder side of haptic media and encodes and encapsulates the haptic media, to form a media file of the haptic media. The consumption device 202 may be used as a decoder side of the haptic media and decodes and consumes the media file of the haptic media, to present the haptic media. In an implementation, the service device 201 may be a terminal device or a server. The consumption device 202 may also be a terminal device or a server. The terminal device may be a smartphone, a tablet computer, a notebook computer, a desktop computer, a smart speaker, a smartwatch, a vehicle-mounted terminal, a smart TV, an intelligent wearable device, an intelligent interactive device, or the like, but is not limited thereto. The server can be an independent physical server, or a server cluster composed of a plurality of physical servers or a distributed system, or can be a cloud server that provides basic cloud computing services such as cloud services, cloud databases, cloud computing, cloud functions, cloud storage, network services, cloud communications, middleware services, domain name services, security services, content delivery networks (CDN), big data, and artificial intelligence platforms. A communication connection may be established between the service device 201 and the consumption device 202.

In an embodiment, a specific procedure in which the service device 201 and the consumption device 202 perform data processing on the haptic media is as follows: The service device 201 mainly includes the following data processing process: (1) a process of obtaining haptic media; and (2) a process of encoding and file encapsulation of the haptic media. The consumption device 202 mainly includes the following data processing process: (3) a process of file decapsulation and decoding of the haptic media; and (4) a presentation process of the haptic media.

In addition, there is a haptic media transmission process between the service device 201 and the consumption device 202. The transmission process may be performed based on various transmission protocols (or transmission signaling). The transmission protocol herein may include but is not limited to: dynamic adaptive streaming over HTTP (DASH) protocol, HTTP live streaming (HLS) protocol, smart media transport protocol (SMTP), transmission control protocol (TCP), and the like.

A data processing process of the haptic media is described in detail below:

(1) A process of obtaining the haptic media.

The service device 201 may obtain the haptic media, where the haptic media may include one or more haptic signals. Different haptic signals may correspond to different manners of obtaining haptic media. For example, for a vibration haptic signal, a manner of obtaining corresponding vibration haptic media may be collecting a vibration haptic signal with a specific frequency and intensity by using a capture device (for example, a sensor) associated with the service device 201. The specific frequency herein may be set according to an actual case. For example, the specific frequency may be set to 20 Hz to 1000 Hz based on a vibration haptic frequency range that can be sensed by humans. The intensity herein may be measured by using amplitude or magnitude of the vibration. For another example: for an electric haptic signal, a manner of obtaining corresponding electric haptic media may be collecting an electric pulse by using a capture device associated with the service device 201, to form an electric haptic signal. The capture device may be determined according to a type of a collected haptic signal, and may include but is not limited to: a camera device, a sensor device, or a scanning device. The camera device may include an ordinary camera, a stereo camera, a light field camera, or the like. The sensor device may include a laser device, a radar device, or the like. The scanning device may include a three-dimensional laser scanning device, and the like.

(2) A process of encoding and file encapsulation of the haptic media.

\textcircled{1} The service device 201 may encode the haptic media, to obtain a bitstream of the haptic media. In an implementation, a haptic signal in the haptic media exists in an original pulse code modulation (PCM) form. An encoding standard for encoding herein may be, for example, a pulse encoding standard or a digital encoding standard, and the bitstream of the formed haptic media may be a binary bitstream.

\textcircled{2} A presentation condition of the haptic media is obtained, and an association relationship between the haptic media and other media is determined according to the presentation condition.

\textcircled{3} Relationship indication information is generated based on the association relationship between the haptic media and the other media.

The presentation condition of the haptic media is a condition that needs to be satisfied when the haptic media is presented. The presentation condition may include at least one of the following: simultaneous presentation and condition trigger presentation. Simultaneous presentation means that the haptic media and other media on which the haptic media depends are simultaneously presented. Condition trigger presentation means that presentation of the haptic media is triggered only when the other media satisfies a trigger condition. In an embodiment, the association relationship may include a dependency relationship between the haptic media and other media. In this case, the relationship indication information may be configured for indicating whether the haptic media depends on the other media during presentation. In an implementation, when the haptic media has a dependency relationship with other media, the association relationship may further include a simultaneous presentation relationship. In this case, the relationship indication information may be configured for indicating whether the haptic media needs to be simultaneously presented with the other media on which the haptic media depends.

In another implementation, when the haptic media has a dependency relationship with other media, the association relationship may further include a condition trigger relationship, and the condition trigger relationship indicates a trigger condition. In this case, the relationship indication information may be configured for indicating that presentation of the haptic media is triggered only when the other media on which the haptic media depends satisfies the trigger condition during presentation. The trigger condition herein may include, but is not limited to, any one or more of the following: a particular object, a particular spatial region, a particular event, a particular viewing angle, a particular sphere region, or a particular viewport. The particular object may include but is not limited to: a person, an animal, a building, an object, and the like. The trigger condition is a particular object: which represents that presentation of the haptic media is triggered when a particular object in other media is presented. For example: presentation of the haptic media is triggered (for example, vibration is outputted) when a dog (a particular object) in video media (other media) is presented. Alternatively, the trigger condition is a particular object: which represents that presentation of the haptic media is triggered when a particular object interacts with a consumer of the other media in a process of consuming the other media. For example, when a consumer of video media walks to a building (a particular object), presentation of the haptic media is triggered. The particular spatial region may be any spatial region in other media. A trigger condition is a particular spatial region: which represents that presentation of the haptic media is triggered when the consumer consumes a particular spatial region in the other media. The particular event may be determined according to a media type of other media. For example, the other media is audio media, and the particular event may include a drum end event, a drum start event, a music start event, and the like in the audio media. For another example: other media is subtitle media, and the particular event may include a subtitle display end event, a subtitle display start event, and the like. The trigger condition is a particular event: which represents that presentation of the haptic media is triggered when the particular event exists in other media. The particular viewing angle refers to a viewing angle of a consumer of other media. The trigger condition is a particular viewing angle: which represents that presentation of the haptic media is triggered when the consumer consumes other media at a particular viewing angle. The particular sphere region may be any spatial region in other media. The trigger condition is a particular sphere region: which represents that presentation of the haptic media is triggered when a particular sphere region in other media is consumed. The particular viewport is a viewport of other media. The trigger condition is a particular viewport: which represents that presentation of the haptic media is triggered when media content of other media is presented in a particular viewport.

Further, after the relationship indication information is generated, the service device 201 may encapsulate the relationship indication information and the bitstream of the haptic media, to obtain the media file of the haptic media. The encapsulation herein may include the following several manners:

1. If the haptic media includes time-sequence haptic media, the bitstream of the haptic media may be encapsulated as a haptic media track, the haptic media track includes one or more samples, and one sample may include one or more haptic signals in the time-sequence haptic media. In addition, the relationship indication information may be added to the haptic media track, to form a media file of the haptic media. Exemplarily, the relationship indication information may be placed at a sample entry of the haptic media track, to form a media file of the haptic media.

2. If the haptic media includes non-time-sequence haptic media, the bitstream of the haptic media and the relationship indication information may be encapsulated as a haptic media item, to form a media file of the haptic media.

After obtaining the media file of the haptic media, the service device 201 may transmit the media file of the haptic media to the consumption device 202, so that the consumption device 202 may decode and consume the bitstream in the media file according to the relationship indication information.

In an embodiment, the media file of the haptic media may be transmitted in a streaming manner. The streaming manner refers to dividing the media file of the haptic media into a plurality of segments for transmission. In this case, the service device 201 and the consumption device 202 transmit the segments of the media file of the haptic media based on transmission signaling. In this case, description information of the relationship indication information may be included in the transmission signaling, and content of the relationship indication information is described by using the description information, so as to guide the consumption device 202 to decode and consume one or more segments of the media file of the haptic media as required.

When the haptic media has an association relationship with other media, the service device 201 further needs to encode the other media to obtain a bitstream of the other media, and encapsulate the bitstream of the other media to obtain a media file of the other media.

(3) A process of file decapsulation and decoding of the haptic media.

The consumption device 202 may obtain the media file of the haptic media and corresponding media presentation description information by using the service device 201. The media presentation description information is configured for describing related information of the media file of the haptic media. For example, the media presentation description information includes description information of the relationship indication information configured for describing the relationship indication information in the media file of the haptic media. The process of file decapsulation of the consumption device 202 is opposite to the process of file encapsulation of the service device 201. The consumption device 202 decapsulates the media file according to a file format requirement of the haptic media, to obtain the bitstream of the haptic media. The process of decoding of the consumption device 202 is opposite to the process of encoding of the service device 201. The consumption device 202 decodes the bitstream to restore the haptic media. In the decoding process, the consumption device 202 may obtain the relationship indication information from the media file, obtain the media file of the haptic media and the media file of the other media based on the association relationship indicated by the relationship indication information, and decode the bitstream of the haptic media and the bitstream of the other media.

In an embodiment, the media file of the haptic media may be transmitted in a streaming manner. In this case, the consumption device 202 may obtain description information of the relationship indication information in transmission signaling (for example, DASH), and obtain, based on the association relationship indicated by the relationship indication information, segments of the media file of the haptic media that needs to be decoded for consumption and a media file of another associated media or segments of the media file for decoding.

(4) A presentation process of the haptic media.

The consumption device 202 may render the haptic media obtained through decoding, to obtain a haptic signal of the haptic media, render the other media obtained through decoding, to obtain a media resource of the other media, and present the haptic media and the other media based on the association relationship between the haptic media and the other media. For example, the haptic media is vibration haptic media, the other media is audio media, and the association relationship between the haptic media and the other media includes a simultaneous presentation relationship. The consumption device 202 renders the haptic media obtained through decoding, to obtain a haptic signal of the haptic media, renders the other media obtained through decoding, to obtain an audio frame of the audio media, and simultaneously presents the haptic signal of the haptic media and the audio frame according to the simultaneous presentation relationship. For another example, the haptic media is vibration haptic media, the other media is audio media, the association relationship between the haptic media and the other media includes a condition trigger relationship, and a trigger condition indicated by the condition trigger relationship includes a drum end event. The consumption device 202 renders the haptic media obtained through decoding, to obtain a haptic signal of the haptic media, renders the other media obtained through decoding, to obtain an audio frame of the audio media, first presents the audio frame in the audio media according to the condition trigger relationship, and when the music drum in the audio frame ends, presents the haptic signal of the haptic media.

In an embodiment, FIG. 2b is a flowchart of data processing of haptic media. The procedure includes:

A data processing procedure of haptic media performed by the service device 201 includes: collecting haptic media B, where the haptic media includes a haptic signal A; encoding the obtained haptic media B, to obtain a bitstream E of the haptic media; and encapsulating the bitstream E to obtain a media file of the haptic media. In an implementation, the service device 201 synthesizes, according to a particular media container file format, one or more bitstreams into a media file F for file playback. In another implementation, the service device 201 processes one or more bitstreams according to a particular media container file format, to obtain initialization segments and segments of the media file (FS) for streaming transmission. The media container file format may be a basic ISO media file format specified in International Organization for Standardization (ISO)/International Electrotechnical Commission (IEC) 14496-12.

A data processing procedure of haptic media performed by the consumption device 202 includes: receiving the media file of the haptic media sent by the service device 201, where the media file may include: a media file F′ for file playback or initialization segments and segments Fs′ of the media file for streaming transmission; decapsulating the media file to obtain a bitstream E′; obtaining relationship indication information from the media file, or obtaining relationship indication information from description information of the relationship indication information included in transmission signaling, and decoding the bitstream based on the relationship indication information (that is, decoding the bitstream based on the association relationship indicated by the relationship indication information), to obtain haptic media D′; rendering the decoded haptic media D′ to obtain a haptic signal A′ of the haptic media; and presenting, based on the association relationship between the haptic media and the other media, the other media and the haptic media on a screen of a head-mounted display or any other display device corresponding to the consumption device 202.

The data processing of the haptic media may be applied to products related to haptic feedback, and a service node (an encoder side), a playback node (a decoder side), and an intermediate node (a relay side) of an immersive system and the like. A data processing technology for haptic media in this disclosure may be implemented depending on a cloud technology. For example, a cloud server is used as an encoder side. The cloud technology refers to a hosting technology that unifies series of resources such as hardware, software, and network in a wide area network or a local area network, to implement computing, storage, processing, and sharing of data.

In this embodiment of this disclosure, on the one hand, the service device (the encoder side) may obtain the presentation condition of the haptic media, determine the association relationship between the haptic media and other media based on the presentation condition, generate the relationship indication information based on the association relationship between the haptic media and the other media, and perform encapsulation processing on the relationship indication information and the bitstream, to obtain the media file of the haptic media. The service device performs data processing on the haptic media, so that the relationship indication information may be added to the media file of the haptic media in the process of encoding the haptic media. In this way, the decoder side (the consumption device) can be effectively guided to accurately present the haptic media based on the association relationship between the haptic media and the other media indicated by the relationship indication information. On the other hand, the consumption device may receive the media file of the haptic media, and decode the bitstream based on the association relationship indicated by the relationship indication information in the media file, to present the haptic media, thereby improving presentation accuracy of the haptic media and improving a presentation effect of the haptic media.

In this embodiment of this disclosure, several descriptive fields may be added to a system layer, including field extension at a file encapsulation level and field extension at a signaling message level, to support implementation operations of this disclosure. Next, extending an ISOBMFF data box and DASH signaling is used as an example to describe a data processing method for haptic media provided in an embodiment of this disclosure.

FIG. 3 is a data processing method for haptic media according to an embodiment of this disclosure. The data processing method for haptic media may be performed by a consumption device (that is, a decoder side), and the data processing method for haptic media may include the following operations S301 and S302.

S301: Obtain a media file of haptic media, the media file including a bitstream and relationship indication information of the haptic media, the relationship indication information being configured for indicating an association relationship between the haptic media and other media, and the other media including media whose media type is a non-haptic type.

The bitstream may be a binary bitstream or other bitstreams (for example, a quaternary bitstream or a hexadecimal bitstream). The other media includes at least one of the following: two-dimensional video media, audio media, volumetric video media, multi-viewing-angle video media, and subtitle media. There may be one or more pieces of other media. When there is a plurality of pieces of other media, media types of the plurality of pieces of other media may be different, or media types of the plurality of pieces of other media may be partially the same. For example, being partially the same is as follows: A total of three pieces of other media are included, media types of two pieces of other media may be the same, and a media type of the remaining other media is different from the media types of the two pieces of other media. This is partially the same. The haptic media may include time-sequence haptic media and non-time-sequence haptic media. The time-sequence haptic media may be encapsulated as a haptic media track in the media file, and the non-time-sequence media may be encapsulated as a haptic media item in the media file. The association relationship may include a dependency relationship between the haptic media and other media.

Next, time-sequence haptic media is encapsulated as a haptic media track in the media file and non-time-sequence haptic media is encapsulated as a non-haptic item in the media file, to describe that the relationship indication information indicates the association relationship between the haptic media and other media.

(1) Time-sequence haptic media is encapsulated as a haptic media track in a media file.

The haptic media track includes one or more samples, and any sample in the haptic media track includes one or more haptic signals of the time-sequence haptic media. The association relationship includes a dependency relationship.

A. The relationship indication information may be placed at a sample entry of the haptic media track.

In an embodiment, the relationship indication information may include a presentation dependency flag (e.g., haptics_dependency_flag). The presentation dependency flag is used for indicating whether a sample in the haptic media track can be independently presented. In an implementation, the haptics_dependency_flag may be placed at a sample entry of a haptic media track. If a sample entry of a haptic media track includes haptics_dependency_flag, when haptics_dependency_flag is a second preset value (for example, “0”), it indicates that a sample in the haptic media track can be independently presented. When the haptics_dependency_flag is a first preset value (for example, “1”), it indicates that the sample in the haptic media track depends on other media during presentation, that is, the sample in the haptic media track cannot be independently presented. In another implementation, if a sample entry of a haptic media track does not include haptics_dependency_flag, it indicates that a sample in the haptic media track can be independently presented. That is, this case is equivalent to the case in which a sample entry of a haptic media track includes haptics_dependency_flag and haptics_dependency_flag is the second preset value. If a sample entry of a haptic media track includes haptics_dependency_flag, it indicates that a sample in the haptic media track depends on other media during presentation. That is, this case is equivalent to the case in which a sample entry of a haptic media track includes haptics_dependency_flag and haptics_dependency_flag is the first preset value.

In an embodiment, the sample entry of the haptic media track may further include a decoder configuration record (AVSHapticsDecoderConfigurationRecord). The decoder configuration record is used for indicating decoder limitation information of the sample in the haptic media track. The decoder configuration record may include a codec type field, a configuration identification field, and a level identification field. Syntax of the decoder configuration record is shown in Table 1:

TABLE 1

aligned(8) class AVSHapticsDecoderConfigurationRecord ( ) {
unsigned int(32) codec_type;
unsigned int(8) profile_id;
unsigned int(8) level_id;
}

Meanings of the fields in Table 1 are as follows:

Codec type field (codec_type): This field is used for indicating a codec type of a sample in a haptic media track. When the codec type field is a second preset value (for example, “0”), the sample in the haptic media track does not need to be decoded. Not needing to be decoded means that a corresponding haptic signal can be directly obtained by parsing according to information in the sample in the haptic media track. When the codec type field is a first preset value (for example, “1”), the sample in the haptic media track needs to be decoded to obtain a haptic signal, and the codec type of the sample in the haptic media track is determined based on the codec type field.

In some embodiments, when the codec type field is a second preset value, the haptic media track only needs to include a time sample data box (TimeToSampleBox) and does not include a composition offset data box (CompositionOffsetBox).

Configuration identification field (profile_id): This field is used for indicating a capability of a decoder required for parsing the haptic media, and a larger value of the configuration identification field indicates a higher capability of the decoder required for parsing the haptic media. The decoder supports parsing the haptic media of the codec type indicated by the codec type field. The capability of the decoder may be measured by using one or more of the following indicators. The indicator may include, but is not limited to, a decoding type, decoding efficiency, and a decoding speed. A larger number of decoding types that can be decoded by the decoder indicates a higher capability of the decoder. Higher decoding efficiency of the decoder indicates a higher capability of the decoder. A higher decoding speed of the decoder indicates a higher capability of the decoder. When the codec type field is the second preset value (for example, “0”), the configuration identification field is the second preset value (that is, “0”).

Level identification field (level_id): This field is used for indicating a capability level of the decoder. Capabilities of the decoder may be divided into a plurality of capability levels, and each capability level corresponds to a capability range. When the configuration identification field is the second preset value (for example, “0”), the level identification field is the second preset value (that is, “0”).

When the value of the codec type field is the second preset value, values of the configuration identification field and the level identification field are both the second preset value.

Syntax of placing the relationship indication information and the decoder configuration record at the sample entry is shown in Table 2, where ‘ahap’ is used for identifying a type of the sample entry:

TABLE 2

aligned(8) class AVSHapticsSampleEntry extends
HapticSampleEntry (‘ahap’) {
AVSHapticsDecoderConfigurationRecord;
unsigned int(1) haptics_dependency_flag;
bit (7) reserved;
}

In an embodiment, when the presentation dependency flag (haptics_dependency_flag) is the first preset value, the relationship indication information further includes reference indication information, and the reference indication information is configured for indicating an encapsulation position of the other media on which the sample in the haptic media track depends during presentation. Exemplarily, the reference indication information may be represented as a track reference data box (TrackReferenceTypeBox), and a reference type of the track reference data box is ‘ahrf’. The track reference data box may be placed in a haptic media track. In an implementation, the track parameter data box may be placed in a track data box of a haptic media track, that is, the track data box of the haptic media track may include a track reference data box whose reference type is ‘ahrf’.

The track reference data box is used for indexing to the track or the track group to which the other media on which the sample in the haptic media track depends during presentation belongs. One track group may include a plurality of tracks. The track reference data box may include a track identification field (track_IDs). The track identification field is used for identifying the track or the track group to which the other media on which the sample in the haptic media track depends during presentation belongs. Syntax of the track reference data box may be shown in Table 3:

TABLE 3
aligned(8) class TrackReferenceTypeBox (‘ahrf’) extends Box(‘ahrf’) {
unsigned int(32) track_IDs[ ];
}

B. A main function of the track reference data box is to indicate a track or a track group to which other media on which the haptic media depends during presentation belongs. Therefore, in this embodiment of this disclosure, whether the haptic media can be independently presented may also be indicated by whether the haptic media track includes the track reference data box. In an embodiment, the relationship indication information includes a track reference data box; and if the track reference data box is not included in the haptic media track, the sample in the haptic media track can be independently presented; and if the track reference data box is included in the haptic media track, the sample in the haptic media track depends on other media during presentation, and the track reference data box can be used for indexing to the track or the track group to which the other media on which the sample in the haptic media track depends during presentation belongs. For details of syntax of the track reference data box, refer to the foregoing Table 3, and details are not described herein again.

In an embodiment, a sample entry of the haptic media track supports extension as required, that is, the sample entry of the haptic media track may further include extended information, and the extended information may include, but is not limited to: a static dependency information field, a dependency information structure number field, and a dependency information structure field. Syntax of including extended information in a sample entry of a haptic media track is shown in Table 4:

TABLE 4

```
aligned(8) class AVSHapticsSampleEntry extends
HapticSampleEntry (‘ahap’) {
AVSHapticsDecoderConfigurationRecord;
unsigned int(1) haptics_dependency_flag;
bit (7) reserved;
if(haptics_dependency_flag == 1){
unsigned int(1) static_haptics_dependency_info;
if(static_haptics_dependency_info == 1){
    unsigned int(8) num_dependency_info_struct;
  for(i=0; i< num_dependency_info_struct; i++){
HapticsDependencyInfoStruct( );
}
}
    bit (7) reserved;
}
}
```

Meanings of the fields included in the extended information in Table 4 are as follows:

Static dependency information field (static_haptics_dependency_info): This field is used for indicating whether the haptic media track has static dependency information, when a value of the static dependency information field is a first preset value (for example, “1”), the haptic media track has static dependency information, and when a value of the static dependency information field is a second preset value (for example, “0”), the haptic media track has no static dependency information; The static dependency information means that other media on which the sample in the haptic media track depends during presentation does not change with time. For example, all samples in the haptic media track depend on an image during presentation, and the dependency relationship does not change with time. In this case, the image is static dependency information of the haptic media track.

Dependency information structure number field (num_dependency_info_struct): This field is used for indicating a number of pieces of dependency information on which the sample in the haptic media track depends during presentation.

Dependency information structure field (HapticsDependencyInfoStruct( ): This field is used for indicating content of dependency information on which the sample in the haptic media track depends during presentation, and the dependency information is valid for all samples in the haptic media track. Being valid herein means being effective, that is, all samples in the haptic media track depend on the dependency information during presentation.

C. When dependency information on which a sample in a haptic media track depends during presentation dynamically changes with time, dependency information on which the sample in the haptic media track depends during presentation is indicated by using a metadata track.

The relationship indication information may include a metadata track, and the metadata track is used for indicating dependency information on which the sample in the haptic media track depends during presentation, and may be used for indicating a dynamic temporal change of the dependency information on which the sample in the haptic media track depends during presentation.

The metadata track includes one or more samples, any sample in the metadata track corresponds to one or more samples in the haptic media track, any sample in the metadata track includes dependency information on which a corresponding sample in the haptic media track depends during presentation, and a sample in the metadata track needs to be aligned in time with a corresponding sample in the haptic media track. For example, if a sample 1 in the metadata track includes audio media, and a sample 2 in the haptic media track depends on the audio media, the sample 1 in the metadata track corresponds to the sample 2 in the haptic media track.

In this embodiment of this disclosure, the metadata track may be associated with the haptic media track based on a track reference of a preset type. The preset type herein may be identified by using “cdsc”. The metadata track includes a dependency information structure number field, a dependency information identification field, a dependency cancellation flag field, and a dependency information structure field. Syntax of the metadata track is shown in Table 5:

TABLE 5

```
  aligned(8) class HapticsDependencyInfoSampleEntry extends
MetaDataSampleEntry (‘ahdm’) {
  }
  aligned(8) class HapticsDependencyInfoSample( ) {
    unsigned int(8) num_dependency_info_struct;
    for (i=0; i < num_dependency_info_struct; i++){
      unsigned int(7) dependency_info_id[i];
      unsigned int(1) dependency_cancel_flag[i];
      if (dependency_cancel_flag [i] == 0) {
        HapticsDependencyInfoStruct[i];
      }
    }
  }
```

Meanings of the fields of the metadata track are as follows:

Dependency information structure number field (num_dependency_info_struct): This field is used for indicating a number of pieces of dependency information included by the sample in the metadata track.

Dependency information identification field (dependency_info_id[i]): This field is used for indicating an identifier of current dependency information, and the current dependency information is dependency information on which a current sample that is being decoded in the haptic media track depends during presentation.

Dependency cancellation flag field (dependency_cancel_flag[i]): This field is used for indicating whether the current dependency information is valid, when a value of the dependency cancellation flag field is a first preset value (for example, “1”), the current dependency information is no longer valid, and when a value of the dependency cancellation flag field is a second preset value (“0”), the current dependency information starts to become valid, and the current dependency information keeps valid until the value of the dependency cancellation flag field is changed to the first preset value. Being valid herein means being effective, that is, a current sample can depend on current dependency information during presentation. Herein, being no longer valid may refer to that the current dependency information is invalid, that is, the current sample does not depend on the current dependency information during presentation. For example, the dependency information 1 is audio media. When a value of the dependency cancellation flag field is the second preset value (“0”), it indicates that the dependency information 1 starts to become valid. When the dependency information 1 starts to become valid, a current sample that is being decoded in the haptic media track depends on the audio media during presentation. After decoding of the current sample that is being decoded in the haptic media track is completed, a next sample in the haptic media track may continue to be decoded. In this case, the dependency information 1 is still valid (that is, the value of the dependency cancellation flag field is still the second preset value), and the next sample in the haptic media track still depends on the audio media during presentation. When the value of the dependency cancellation flag field is changed to the first preset value, the dependency information 1 is no longer valid.

Dependency information structure field (HapticsDependencyInfoStruct[i]): This field is used for indicating content of current dependency information (that is, dependency_info_id[i]).

(2) The haptic media includes non-time-sequence haptic media. The non-time-sequence haptic media is encapsulated as a haptic media item in a media file. One haptic media item may include one or more haptic signals of the non-time-sequence haptic media.

In an embodiment, an entity group whose entity group type is ‘ahde’ is generated based on the haptic media item and other media on which the haptic media item depends. In this case, the relationship indication information may include an entity group, the entity group may include one or more entities, and each entity may include a haptic media item or other media. The entity group is used for indicating a dependency relationship between a haptic media item in the entity group and other media in the entity group. The other media may include time-sequence media (for example, video media) and/or non-time-sequence media (for example, image media).

The entity group may include an entity group identification field, an entity number field, and an entity identification field. Syntax of the entity group is shown in Table 6:

TABLE 6

```
  aligned(8) class AVSHapticsDenpendencyEntityBox extends
EntityToGroupBox(‘ahde’) {
  unsigned int(32) group_id;
      unsigned int(32) num_entities_in_group;
      for(i=0; i<num_entities_in_group; i++){
      unsigned int(32) entity_id;
    }
  }
```

Meanings of the fields in the entity group are as follows:

Entity group identification field (group_id): This field is used for indicating an identifier of the entity group, and different entity groups have different identifiers.

Entity number field (num_entities_in_group): This field is used for indicating a number of entities in the entity group.

Entity identification field (entity_id): This field is used for indicating an entity identifier in the entity group, the entity identifier is the same as an item identifier of an item to which an identified entity belongs, or the entity identifier is the same as a track identifier of a track to which the identified entity belongs, and different entities have different entity identifiers; where if the entity identifier indicated by the entity identification field is used for identifying a haptic media item in the entity group, the haptic media item in the entity group depends on other media in the entity group during presentation, and if the entity identifier indicated by the entity identification field is used for identifying other media in the entity group, presentation of the other media in the entity group affects presentation of a haptic media item in the entity group.

In an embodiment, the haptic media item has one or more dependency properties, and the dependency property may be used for indicating dependency information on which the haptic media item depends during presentation. The dependency property may include a dependency information structure number field and a dependency information structure field. Syntax of the dependency property is shown in Table 7:

TABLE 7

```
aligned(8) class HapticsDependencyInfoProperty
    extends ItemFullProperty(‘ahdp’, 0, 0)
{
  unsigned int(8) num_dependency_info_struct;
  for (i=0; i < num_dependency_info_struct; i++){
    HapticsDependencyInfoStruct[i];
  }
}
```

Meanings of the fields in the dependency property are as follows:

Dependency information structure number field (num_dependency_info_struct): This field is used for indicating a number of pieces of dependency information on which the haptic media item depends during presentation.

Dependency information structure field (HapticsDependencyInfoStruct[i]): This field is used for indicating content of dependency information (that is, HapticsDependencyInfoStruct[i]) on which the haptic media item depends during presentation.

In this embodiment of this disclosure, the dependency information structure field described above may include one or more of the following fields: a presentation dependency flag field, a simultaneous dependency flag field, an object dependency flag field, a spatial region dependency flag field, an event dependency flag field, a viewing angle dependency flag field, a sphere region dependency flag field, a viewport dependency flag field, a media type number field, a media type field, an object identification field, a spatial region structure field, an event label field, a viewing angle identification field, a sphere region structure field, and a viewport identification field. Syntax of the dependency information structure field is shown in Table 8:

TABLE 8

```
aligned(8) class HapticsDependencyInfoStruct ( ) {
unsigned int(1) presentation_dependency_flag;
unsigned int(1) object_dependency_flag;
unsigned int(1) spatial_dependency_flag;
unsigned int(1) event_dependency_flag;
unsigned int(1) view_dependency_flag;
unsigned int(1) sphere_region_dependency_flag;
unsigned int(1) viewport_dependency_flag;
bit (1) reserved;
if (presentation_dependency_flag = = 1) {
    unsigned int (1) simultaneous_dependency_flag;
    if(simultaneous_dependency_flag == 1){
      unsigned int(7) media_type_number;
      for(i=0; i< media_type_number; i++){
    unsigned int(8) media_type;
}
}
else
  bit (7) reserved;
}
if(object_dependency_flag == 1){
    unsigned int(32) object_id;
}
if(spatial_dependency_flag == 1){
PCC3DSpatialRegionStruct( ):
}
if(event_dependency_flag == 1){
    string event_label;
}
if(view_dependency_flag == 1){
    unsigned int(32) view_id;
}
if(sphere_region_dependency_flag == 1){
    SphereRegionStruct ( );
}
if(viewport_dependency_flag == 1){
  unsigned int(32) viewport_id;
}
}
```

Meanings of the fields in the dependency information structure field are as follows:

Presentation dependency flag field (presentation_dependency_flag): This field is used for indicating whether a current haptic media resource needs to be simultaneously presented with other media on which the current haptic media resource depends during presentation. When a value of the presentation dependency flag field is a first preset value (for example, “1”), the current haptic media resource needs to be simultaneously presented with the other media on which the current haptic media resource depends during presentation, that is, the haptic media can be presented only when the other media is presented correctly in a corresponding presentation time. When a value of the presentation dependency flag field is a second preset value (for example, “0”), the current haptic media resource does not need to be simultaneously presented with the other media on which the current haptic media resource depends during presentation. For example, if vibration haptic media is triggered by audio media, a presentation time of an audio media track needs to be consistent with a presentation time of a haptic media track. If the audio media is not successfully presented, for example, the audio media is suddenly muted or decoding of the audio media track fails, even if the haptic media track can be decoded, the haptic media is not presented. When the value of the presentation dependency flag field is the first preset value, the dependency information structure field includes a simultaneous dependency flag field (simultaneous_dependency_flag). The simultaneous dependency flag field is used for indicating a media type on which the current haptic media resource simultaneously depends during presentation. When a value of the simultaneous dependency flag field is a first preset value (for example, “1”), the current haptic media resource simultaneously depends on a plurality of media types during presentation. When a value of the simultaneous dependency flag field is a second preset value (for example, “0”), the current haptic media resource depends, during presentation, on only any one of a plurality of media types to which the current haptic media resource refers.

Object dependency flag field (object_dependency_flag): This field is used for indicating whether the current haptic media resource depends on a particular object in other media during presentation, that is, indicating whether presentation of the current haptic media resource is triggered by the particular object in the other media during presentation. When a value of the object dependency flag field is a first preset value (for example, “1”), the current haptic media resource depends on a particular object in the other media during presentation. In this case, the dependency information structure field further includes an object identification field (object_id), and the object identification field is used for indicating an identification of the particular object on which the current haptic media resource depends during presentation. When a value of the object dependency flag field is a second preset value (for example, “0”), the current haptic media resource does not depend on a particular object in the other media during presentation.

Spatial region dependency flag field (spatial_dependency_flag): This field is used for indicating whether the current haptic media resource depends on a particular spatial region in other media during presentation, that is, indicating that presentation of the current haptic media resource is triggered by the particular spatial region in the other media during presentation. When a value of the spatial region dependency flag field is a first preset value (for example, “1”), the current haptic media resource depends on a particular spatial region in the other media during presentation. In this case, the dependency information structure field further includes a spatial region structure field (PCC3DSpatialRegionStruct), and the spatial region structure field is used for indicating information about the particular spatial region on which the current haptic media resource depends during presentation. When a value of the spatial region dependency flag field is a second preset value (for example, “0”), the current haptic media resource does not depend on a particular spatial region in the other media during presentation.

Event dependency flag field (event_dependency_flag): This field is used for indicating whether the current haptic media resource depends on a particular event in other media during presentation, that is, indicating whether presentation of the current haptic media resource is triggered by the particular event in the other media during presentation. When a value of the event dependency flag field is a first preset value (for example, “1”), presentation of the current haptic media resource is triggered by the particular event in the other media during presentation, that is, the current haptic media resource depends on the particular event in the other media during presentation. In this case, the dependency information structure field further includes an event label field (event_label), and the event label field is used for indicating a label of the particular event on which the current haptic media resource depends during presentation. When a value of the event dependency flag field is a second preset value (for example, “0”), the current haptic media resource does not depend on a particular event in the other media during presentation.

Viewing angle dependency flag field (view_dependency_flag): This field is used for indicating whether the current haptic media resource depends on a particular viewing angle during presentation, that is, indicating whether presentation of the current haptic media resource is triggered by the particular viewing angle in the other media during presentation. When a value of the viewing angle dependency flag field is a first preset value (for example, “1”), the current haptic media resource depends on a particular viewing angle during presentation. In this case, the dependency information structure field further includes a viewing angle identification field (view_id), and the viewing angle identification field is used for indicating an identification of the particular viewing angle on which the current haptic media resource depends during presentation. When a value of the viewing angle dependency flag field is a second preset value (for example, “0”), the current haptic media resource does not depend on a particular viewing angle during presentation.

Spherical region dependency flag field (sphere_region_dependency_flag): This field is used for indicating whether the current haptic media resource depends on a particular sphere region during presentation, that is, indicating whether presentation of the current haptic media resource is triggered by the particular sphere region in the other media during presentation. When a value of the sphere region dependency flag field is a first preset value (for example, “1”), the current haptic media resource depends on a particular sphere region during presentation. In this case, the dependency information structure field further includes a sphere region structure field (SphereRegionStruct), and the sphere region structure field is used for indicating information about the particular sphere region on which the current haptic media resource depends during presentation. When a value of the sphere region dependency flag field is a second preset value (for example, “0”), the current haptic media resource does not depend on a particular sphere region during presentation.

Viewport dependency flag field (viewport_dependency_flag): This field is used for indicating whether the current haptic media resource depends on a particular viewport during presentation, that is, indicating whether presentation of the current haptic media resource is triggered by the particular viewport in the other media during presentation. When a value of the viewport dependency flag field is a first preset value (for example, “1”), the current haptic media resource depends on a particular viewport during presentation. In this case, the dependency information structure field further includes a viewport identification field (viewport_id), and the viewport identification field is used for indicating an identification of the particular viewport on which the current haptic media resource depends during presentation. When a value of the viewport dependency flag field is a second preset value (for example, “0”), the current haptic media resource does not depend on a particular viewport during presentation.

Media type number field (media_type_number): This field is used for indicating a number of types of media on which the current haptic media resource simultaneously depends during presentation.

Media type field (media_type): This field is used for indicating a media type of other media on which the current haptic media resource depends during presentation. Different values of the media type field indicate different types of media on which the current haptic media resource depends during presentation. When a value of the media type field is a first preset value (for example, “1”), a media type on which the current haptic media resource depends during presentation is two-dimensional video media. When a value of the media type field is a second preset value (for example, “0”), a media type on which the current haptic media resource depends during presentation is audio media. When a value of the media type field is a third preset value (for example, “2”), a media type on which the current haptic media resource depends during presentation is volumetric video media. When a value of the media type field is a fourth preset value (for example, “3”), a media type on which the current haptic media resource depends during presentation is multi-viewing-angle video media. When a value of the media type field is a fifth preset value (for example, “4”), a media type on which the current haptic media resource depends during presentation is subtitle media. A value of the media type field may be defined as required, and is not limited in this disclosure.

In this embodiment of this disclosure, the current haptic media resource is haptic media that is being decoded in the bitstream, and the current haptic media resource includes any one or more of the following: a haptic media track, a haptic media item, and some samples in the haptic media track. The current haptic media resource may be determined according to an effect range of the dependency information structure field.

The spatial region structure field may include a coordinate presentation flag field and a region dimension flag field. Syntax of the spatial region structure field is shown in Table 9:

TABLE 9

```
aligned(8) class PCC3DSpatialRegionStruct
(coordinate_present_flag , dimensions_included_flag) {
    unsigned int(16) 3d_region_id;
if(coordinate_present_flag){
  3DPoint anchor;
  if (dimensions_included_flag) {
      CuboidRegionStruct( );
}
}
}
aligned(8) class 3DPoint( ) {
  unsigned int(16) x;
  unsigned int(16) y;
  unsigned int(16) z;
}
aligned(8) class CuboidRegionStruct( ) {
  unsigned int(16) cuboid_dx;
  unsigned int(16) cuboid_dy;
  unsigned int(16) cuboid_dz;
}
```

Meanings of the fields included in the spatial region structure field are as follows:

Coordinate presentation flag field (coordinate_present_flag): This field is used for indicating whether there is specific coordinate information of a current spatial region. When a value of the coordinate presentation flag field is a first preset value (for example, 1), it indicates that there is specific coordinate information of a current spatial region. When a value of the coordinate presentation flag field is a second preset value (for example, 0), it indicates that there is no specific coordinate information of a current spatial region.

Region dimension flag field (dimensions_included_flag): This field is used for indicating whether a spatial region dimension has been identified. When a value of the region dimension flag field is a first preset value (for example, “1”), it indicates that a spatial region dimension has been identified. In this case, the spatial region structure field indicates a cuboid region in space. When a value of the region dimension flag field is a second preset value (for example, “0”), it indicates that a spatial region dimension has not been identified. In this case, the spatial region structure field indicates a point in space.

Spatial region identification field (3d_region_id): This field is used for indicating identification information of a spatial region, that is, an identifier of the spatial region.

Anchor field (anchor): This field is used for indicating an anchor point as a 3D spatial region in a Cartesian coordinate system, and coordinates of the anchor point are defined by a field of 3DPoint( ).

x, y, and z respectively indicate x, y, and z coordinate values of a 3D point in the Cartesian coordinate system. Cuboid_dx, cuboid_dy, and cuboid_dz respectively indicate extensions of a 3D spatial region relative to the anchor point on x, y, and z axes in the Cartesian coordinate system.

This embodiment of this disclosure relates to a sphere region structure field. The sphere region structure field may include an azimuth angle field, an elevation angle field, a tilt angle field, an azimuth range field, and an elevation range field. Syntax of the sphere region structure field is shown in Table 10:

TABLE 10

```
    aligned(8) SphereRegionStruct(range_included_flag) {
  signed int(32) centre_azimuth;
  signed int(32) centre_elevation;
  singed int(32) centre_tilt;
  if (range_included_flag) {
    unsigned int(32) azimuth_range;
    unsigned int(32) elevation_range;
  }
}
```

Meanings of the fields in the sphere region structure field are as follows:

Azimuth angle (centre_azimuth): This field indicates a value of an azimuth angle in a sphere region with 2⁻¹⁶ precision. A range of centre_azimuth is [−π*2¹⁶, π*2¹⁶−1].

Elevation angle field (centre_elevation): This field indicates a value of an elevation angle in a sphere region with 2⁻¹⁶ precision. A range of centre_elevation is [−π/2*2¹⁶, π/2*2¹⁶−1].

Tilt angle field (centre_tilt): This field indicates a value of a tilt angle in a sphere region with 2⁻¹⁶ precision. A range of centre_tilt is [−180°*2¹⁶, 180°*2¹⁶−1].

Azimuth angle range field (azimuth_range): This field indicates an azimuth angle range in a sphere region with 2⁻¹⁶ precision. The azimuth range field may exist or may not exist.

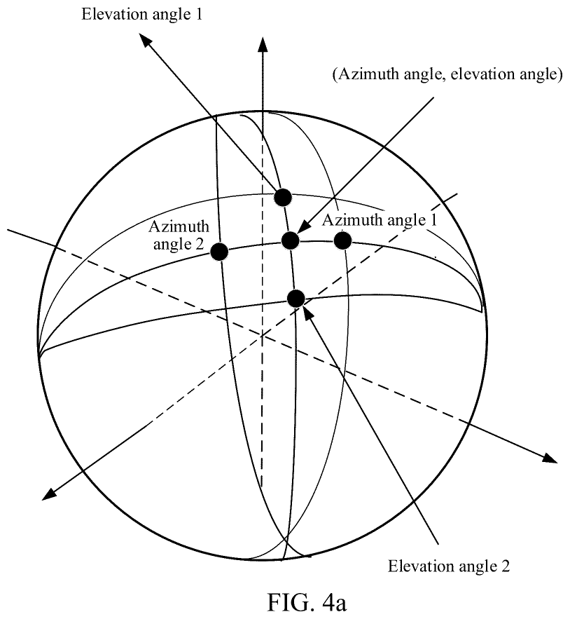

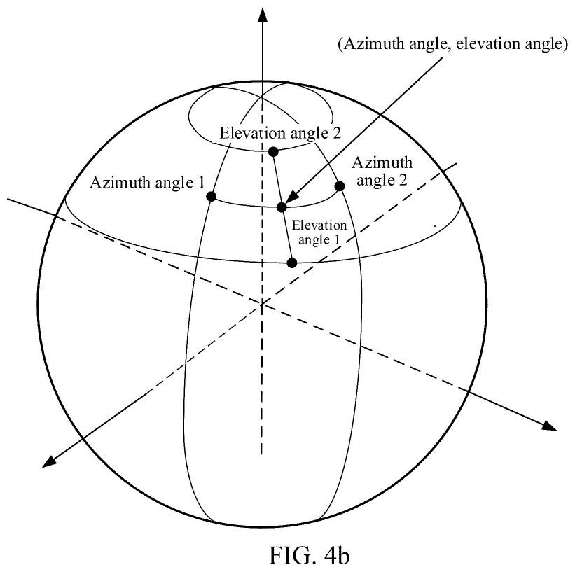

Elevation angle range field (elevation_range): This field indicates an elevation angle range in a sphere region with 2⁻¹⁶ precision. The elevation angle range field may exist or may not exist. The azimuth_range and the elevation_range indicate a range passing through the center of the sphere region, as shown in FIG. 4a and FIG. 4b. FIG. 4a shows a sphere region determined based on four great circles. FIG. 4b shows a sphere region determined based on two azimuth angle circles and two elevation angle circles. When azimuth_range and elevation_range do not exist in an instance of SphereRegionStruct, azimuth_range and elevation_range are specified in structural semantics including an instance of SphereRegionStruct. A range of azimuth_range is [0, 2π*2¹⁶], and a range of elevation_range is [0, π*2¹⁶]. When a shape type value is 1, it is specified that a sphere region determined based on two azimuth angle circles and two elevation angle circles is shown in FIG. 4b.

In an embodiment, when there is a dependency relationship between the haptic media and other media, the association relationship between the haptic media and the other media may further include a simultaneous presentation relationship and/or a condition trigger relationship. In this case, fields included in the dependency information structure field may be determined according to the simultaneous presentation relationship and the condition trigger relationship in the association relationship:

(1) The association relationship includes a simultaneous presentation relationship.

In an embodiment, the dependency information structure field may include a presentation dependency flag field. The presentation dependency flag field is used for indicating whether a current haptic media resource needs to be simultaneously presented with other media on which the current haptic media resource depends during presentation. Further, when a value of the presentation dependency flag field is a first preset value, the dependency information structure field may further include a simultaneous dependency flag field, a media type number field, and a media type field. The simultaneous dependency flag field is used for indicating a media type on which a current haptic media resource simultaneously depends during presentation. The media type number field is used for indicating a number of types of media on which a current haptic media resource simultaneously depends during presentation. The media type field is used for indicating a media type of other media on which the current haptic media resource depends during presentation. In another embodiment, the dependency information structure field may include a presentation dependency flag field, an object dependency flag field, a spatial region dependency flag field, an event dependency flag field, a viewing angle dependency flag field, a sphere region dependency flag field, and a viewport dependency flag field. In this case, a value of the presentation dependency flag field may be a first preset value, and values of other fields in the dependency relationship structure field may all be a second preset value. Further, when the value of the presentation dependency flag field is the first preset value, the dependency information structure field may further include a simultaneous dependency flag field, a media type number field, and a media type field.

(2) The association relationship includes a condition trigger relationship.

The condition trigger relationship indicates a trigger condition, and the trigger condition may include at least one of the following: a particular object, a particular spatial region, a particular event, a particular viewing angle, a particular sphere region, or a particular viewport. In this case, the dependency information structure field includes at least one of the following fields: an object dependency flag field, a spatial region dependency flag field, an event dependency flag field, a viewing angle dependency flag field, a sphere region dependency flag field, and a viewport dependency flag field.

In an embodiment, a field included in the event dependency flag field is determined according to a trigger condition indicated by the condition trigger relationship. For example, the trigger condition is a particular object. In this case, the dependency information structure field includes an object dependency flag field. Further, when the value of the object dependency flag field is the first preset value, the dependency information structure field further includes an object identification field. For another example, the trigger condition is a particular event. In this case, the dependency information structure field includes an event dependency flag field. Further, when the value of the event dependency flag field is the first preset value, the dependency information structure field further includes an event label field.

In another embodiment, the dependency information structure field may include a presentation dependency flag field, an object dependency flag field, a spatial region dependency flag field, an event dependency flag field, a viewing angle dependency flag field, a sphere region dependency flag field, and a viewport dependency flag field. In this case, a value of a field corresponding to the trigger condition is the first preset value, and values of the remaining fields are all the second preset value. For example, the trigger condition is a particular object. In this case, a value of the object dependency flag field in the dependency information structure field is the first preset value, and values of remaining fields in the dependency information structure field are all the second preset value. Further, when the value of the object dependency flag field is the first preset value, the dependency information structure field further includes an object identification field. A field included in the dependency information structure field is not limited in this embodiment of this disclosure.

In an embodiment, the haptic media may be transmitted in a streaming manner, and the obtaining a media file of a haptic media may include: obtaining transmission signaling of the haptic media, where the transmission signaling includes description information of the relationship indication information, and obtaining the media file of the haptic media according to the transmission signaling. The transmission signaling may be DASH signaling, MPD signaling, or the like. The association relationship includes a dependency relationship, and the description information may include at least one of the following: a preselected set and a dependency information descriptor.

(1) The description information may include a preselected set.

In a transmission signaling layer, the haptic media and other media on which the haptic media depends are defined by a preselected set (for example, a DASH preselected set). The preselected set may be used for defining the haptic media and the other media on which the haptic media depends indicated by the relationship indication information. The preselected set includes an identifier list of a preselection component property (@ preselectionComponents), and the identifier list includes an adaption set corresponding to the haptic media (Main Adaptation Set) and an adaption set corresponding to other media (Component Adaptation Set). In an embodiment, a codec (@ codecs) property of the preselected set may be set to a preset type, and the preset type may be “ahap”. When the codec property is set to a preset type, it indicates that media in the preselected set is the haptic media and other media on which the haptic media depends during presentation.

If the media file includes a metadata track, the preselected set further includes an adaption set corresponding to the metadata track. Each adaption set in the preselected set has a media type element field (@mediaType), the media type element field is used for indicating a media type of media corresponding to the adaption set, and a value of the media type element field is any one or more of the following: a sample entry type of a track to which media corresponding to an adaption set belongs, a handler type of a track to which media corresponding to an adaption set belongs, a type of an item to which media corresponding to an adaption set belongs, or a handler type of an item to which media corresponding to an adaption set belongs.

(2) The description information includes a dependency information descriptor.

A dependency information descriptor may be represented by a SupplementalProperty element whose @schemeIdUri property value is “urn:avs:haptics:dependency Info”. The SupplementalProperty element is an element in an MPD file, is used to provide additional property information related to a video stream, may include various customized properties and values, and is used to transfer some additional information related to video content, quality, copyright, and the like. In this embodiment of this disclosure, there may be one or more dependency information descriptors. The dependency information descriptor is used for defining dependency information on which a haptic media resource depends during presentation, and the dependency information descriptor is used for describing a media resource of at least one of the following levels: a haptic media resource of a representation level, a haptic media resource of an adaption set level, or a haptic media resource of a preselection level.

When the dependency information descriptor is used for describing a media resource of the adaption set level, all haptic media resources of the representation level in the media resource of the adaption set level depend on the same dependency information. When the dependency information descriptor is used for describing a media resource of the preselection level, all haptic media resources of the representation level in the media resource of the preselection level depend on the same dependency information.

In an embodiment, if the dependency information descriptor exists in the transmission signaling and the preselected set does not include the metadata track, the dependency information descriptor is valid for each sample corresponding to the described haptic media resource. If the dependency information descriptor exists in the transmission signaling and the preselected set includes the metadata track, the dependency information descriptor is valid for some samples corresponding to the described haptic media resource, and the some samples are determined based on samples in the metadata track. The some samples determined based on the samples in the metadata track are samples that depend on dependency information included in the samples in the metadata track. For example, the samples in the metadata track include video media, and the some samples are samples that depend on the video media included in the samples in the metadata track and that are aligned in time with the samples in the metadata track. Syntax and semantics of the dependency information descriptor are shown in Table 11:

TABLE 11
Syntax and semantics of dependency information descriptor

| Element and property of | | | |
|---|---|---|---|
| dependency information | | | |
| descriptor | Use | Data type | Description |
| AVSHapticsDependencyInfo | 0, . . . , and N | avs:haptics:dependencyInfo | The dependency information |
| (dependency information | | | element field is used for |
| element field) | | | indicating dependency |
| | | | information on which a |
| | | | haptic media resource |
| | | | depends |
| AVSHapticsDependencyInfo | Mandatory | xs: bool | When a value of this field is |
| @presentation_dependency_flag | | | a first preset value (for |
| (presentation dependency | | | example, 1), a current haptic |
| flag element field) | | | media resource needs to be |
| | | | simultaneously presented |
| | | | with other media during |
| | | | presentation, that is, haptic |
| | | | media can be presented only |
| | | | when the other media is |
| | | | presented correctly in a |
| | | | corresponding presentation |
| | | | time. When a value of this |
| | | | field is a second preset value |
| | | | (for example, 0), a current |
| | | | haptic media resource does |
| | | | not need to be |
| | | | simultaneously presented |
| | | | with other media during |
| | | | presentation. |
| AVSHapticsDependencyInfo | Conditionally | xs: bool | When a value of |
| @ | mandatory | | @presentation_dependency_{—} |
| simultaneous_dependency_flag | | | flag is a first preset value |
| (simultaneous dependency | | | (for example, “1”), this field |
| flag element field) | | | is mandatory. In this case, |
| | | | when a value of the |
| | | | simultaneous dependency |
| | | | flag element field is a first |
| | | | preset value (for example, |
| | | | “1”), a current haptic media |
| | | | resource simultaneously |
| | | | depends on a plurality of |
| | | | media types during |
| | | | presentation. When a value |
| | | | of the simultaneous |
| | | | dependency flag element |
| | | | field is a second preset value |
| | | | (for example, “0”), a current |
| | | | haptic media resource |
| | | | depends, during |
| | | | presentation, on only any |
| | | | one of a plurality of |
| | | | reference media types to |
| | | | which the current haptic |
| | | | media resource refers. |
| AVSHapticsDependencyInfo | Conditionally | xs: | When a value of |
| @depend_media_type | mandatory | UIntVectorType | @simultaneous_dependency_{—} |
| (media type element field) | | | flag is 1, the field is |
| | | | mandatory, and the media |
| | | | type element field indicates |
| | | | a media type of other media |
| | | | on which the haptic media |
| | | | simultaneously depends. |
| | | | When a value of the field is |
| | | | a first preset value (for |
| | | | example, “1”), a media type |
| | | | on which the current haptic |
| | | | media resource depends |
| | | | during presentation is two- |
| | | | dimensional video media. |
| | | | When a value of the field is |
| | | | a second preset value (for |
| | | | example, “0”), a media type |
| | | | on which the current haptic |
| | | | media resource depends |
| | | | during presentation is audio |
| | | | media. When a value of the |
| | | | field is a third preset value |
| | | | (for example, “2”), a media |
| | | | type on which the current |
| | | | haptic media resource |
| | | | depends during presentation |
| | | | is volumetric video media. |
| | | | When a value of the field is |
| | | | a fourth preset value (for |
| | | | example, “3”), a media type |
| | | | on which the current haptic |
| | | | media resource depends |
| | | | during presentation is multi- |
| | | | viewing-angle video media. |
| | | | When a value of the field is |
| | | | a fifth preset value (for |
| | | | example, “4”), a media type |
| | | | on which the current haptic |
| | | | media resource depends |
| | | | during presentation is |
| | | | subtitle media. Values of the |
| | | | remaining fields may be |
| | | | self-defined. |
| AVSHapticsDependencyInfo | Optional | xs: bool | When a value of this field is |
| @object_dependency_flag | | | a first preset value (for |
| (object dependency flag | | | example, “1”), a current |
| element field) | | | haptic media resource |
| | | | depends on a particular |
| | | | object in other media during |
| | | | presentation. When a value |
| | | | of this field is a second |
| | | | preset value (for example, |
| | | | “0”), a current haptic media |
| | | | resource does not depend on |
| | | | a particular object in other |
| | | | media during presentation. |
| AVSHapticsDependencyInfo | Conditionally | xs: unsignedInt | The field is used for |
| @object_id (object | mandatory | | indicating an identifier of a |
| identification element field) | | | particular object on which |
| | | | the haptic media resource |
| | | | depends during presentation. |
| AVSHapticsDependencyInfo | Optional | xs: bool | When a value of this field is |
| @spatial_dependency_flag | | | a first preset value (for |
| (spatial region dependency | | | example, “1”), a current |
| flag element field) | | | haptic media resource |
| | | | depends on a particular |
| | | | spatial region of other media |
| | | | during presentation, that is, |
| | | | presentation of the current |
| | | | haptic media resource is |
| | | | triggered when the particular |
| | | | spatial region of the other |
| | | | media is viewed. When a |
| | | | value of this field is a second |
| | | | preset value (for example, |
| | | | “0”), a current haptic media |
| | | | resource does not depend on |
| | | | a particular spatial region in |
| | | | other media during |
| | | | presentation. |
| AVSHapticsDependencyInfo | Conditionally | Particular data | This field is used for |
| @PCC3DSpatialRegionStru | mandatory | structure | indicating information of a |
| ct (spatial region structure | | | particular spatial region on |
| element field) | | | which a current haptic media |
| | | | resource depends during |
| | | | presentation. |
| AVSHapticsDependencyInfo | Optional | xs: bool | When a value of this field is |
| @event_dependency_flag | | | a first preset value (for |
| (event dependency flag | | | example, “1”), a current |
| field) | | | haptic media resource is |
| | | | triggered by a particular |
| | | | event in other media during |
| | | | presentation. When a value |
| | | | of this field is a second |
| | | | preset value (for example, |
| | | | “0”), a current haptic media |
| | | | resource does not depend on |
| | | | a particular event in other |
| | | | media during presentation. |
| AVSHapticsDependencyInfo | Conditionally | xs: string | This field is for indicating a |
| @event_label (event label | mandatory | | label of a particular event on |
| element field) | | | which a current haptic media |
| | | | resource depends during |
| | | | presentation. |
| AVSHapticsDependencyInfo | Optional | xs: bool | When a value of the viewing |
| @view_dependency_flag | | | angle dependency flag |
| (viewing angle dependency | | | element field is a first preset |
| flag element field) | | | value (for example, “1”), a |
| | | | current haptic media |
| | | | resource depends on a |
| | | | particular viewing angle |
| | | | during presentation. When a |
| | | | value of the viewing angle |
| | | | dependency flag element |
| | | | field is a second preset value |
| | | | (for example, “0”), a current |
| | | | haptic media resource does |
| | | | not depend on a particular |
| | | | viewing angle during |
| | | | presentation. |
| AVSHapticsDependencyInfo | Conditionally | xs: string | The field is used for |
| @view_id (viewing angle | mandatory | | indicating an identifier of a |
| identification element field) | | | particular viewing angle on |
| | | | which a current haptic media |
| | | | resource depends during |
| | | | presentation. |
| AVSHapticsDependencyInfo | Optional | xs: bool | When a value of this field is |
| @sphere_region_dependency_flag | | | a first preset value (for |
| (sphere region | | | example, “1”), a current |
| dependency flag element | | | haptic media resource |
| field) | | | depends on a particular |
| | | | sphere region during |
| | | | presentation, that is, |
| | | | presentation of the current |
| | | | haptic media resource is |
| | | | triggered when a particular |
| | | | sphere region in other media |
| | | | is viewed. When a value of |
| | | | this field is a second preset |
| | | | value (for example, “0”), a |
| | | | current haptic media |
| | | | resource does not depend on |
| | | | a particular sphere region |
| | | | during presentation. |
| AVSHapticsDependencyInfo | Conditionally | Particular data | This field is used for |
| @SphereRegionStruct | mandatory | structure | indicating information of a |
| (sphere region structure | | | particular sphere region on |
| element field) | | | which a current haptic media |
| | | | resource depends during |
| | | | presentation. |
| AVSHapticsDependencyInfo | Optional | xs: bool | When a value of this field is |
| @viewport_dependency_flag | | | a first preset value (for |
| (viewport dependency flag | | | example, “1”), a current |
| element field) | | | haptic media resource |
| | | | depends on a particular |
| | | | viewport during |
| | | | presentation. When a value |
| | | | of this field is a second |
| | | | preset value (for example, |
| | | | “0”), a current haptic media |
| | | | resource does not depend on |
| | | | a particular viewport during |
| | | | presentation. |
| AVSHapticsDependencyInfo | Conditionally | xs: string | The field is for indicating an |
| @viewport_id (viewport | mandatory | | identifier of a particular |
| identification element field) | | | viewport on which a current |
| | | | haptic media resource |
| | | | depends during presentation. |

The current haptic media resource is haptic media that is being decoded in the bitstream, and the current haptic media resource includes any one or more of the following: a haptic media track, a haptic media item, and some samples in the haptic media track.

S302: Decode the bitstream according to the relationship indication information, to present the haptic media.

In an embodiment, the decoding the bitstream according to the relationship indication information, to present the haptic media may include the following operations: obtaining, based on the association relationship indicated by the relationship indication information, the other media associated with the haptic media; and decoding the haptic media and the other media; and presenting the other media and the haptic media based on the association relationship. In another embodiment, when the haptic media is transmitted in a streaming manner, the consumption device may determine, according to description information of the relationship indication information, other media associated with the haptic media, and obtain the other media from the service device; and decode the obtained other media and haptic media, and present the other media and the haptic media based on the association relationship.

In an implementation, when the association relationship includes a simultaneous presentation relationship, a specific implementation of presenting the other media and the haptic media based on the association relationship may be: according to the simultaneous presentation relationship, simultaneously presenting the other media and the haptic media at a specific presentation time. For example, the other media is audio media, and the haptic media is vibration haptic media. The audio media and the vibration haptic media may be simultaneously presented in the fifth second according to the simultaneous presentation relationship. In an implementation, when the association relationship includes a condition trigger relationship, a specific implementation of presenting the other media and the haptic media based on the association relationship may be: first presenting the other media, and presenting the haptic media when a trigger condition indicated by the condition trigger relationship is triggered when the other media is presented. For example, if the trigger condition indicated by the condition trigger relationship is a particular event, the other media is first presented, and when the particular event is presented in the other media, presentation of the haptic media is triggered.

In the embodiments of this disclosure, a consumption device may obtain the media file of the haptic media, the media file including a bitstream and relationship indication information of the haptic media, and the relationship indication information being configured for indicating an association relationship between the haptic media and other media (including media whose media type is a non-haptic type), and decode the bitstream according to the relationship indication information, to present the haptic media. In the embodiments of this disclosure, an encoder side (a service device) may add the relationship indication information to the media file of the haptic media in the process of encoding the haptic media. In this way, the decoder side (the consumption device) can be effectively guided to accurately present the haptic media based on the association relationship between the haptic media and the other media indicated by the relationship indication information, thereby improving presentation accuracy of the haptic media and improving a presentation effect of the haptic media.

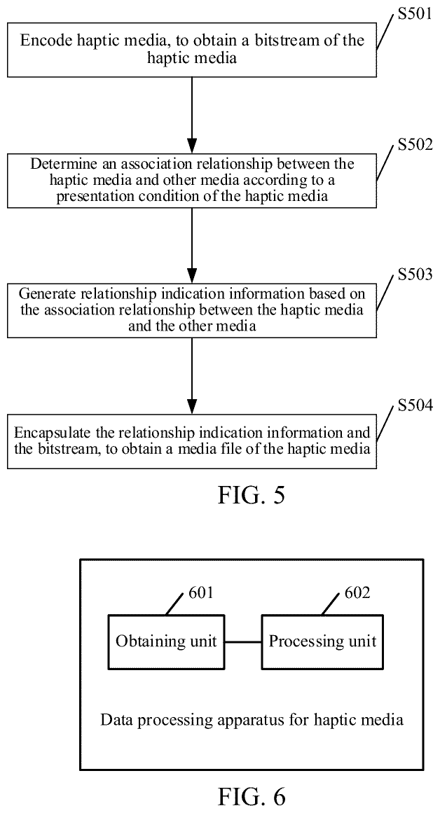

FIG. 5 is a schematic flowchart of a data processing method for haptic media according to an embodiment of this disclosure. The data processing method for haptic media may be performed by a service device (that is, an encoder side), and the data processing method for haptic media may include the following operations S501 to S504.

S501: Encode haptic media, to obtain a bitstream of the haptic media.

S502: Determine an association relationship between the haptic media and other media according to a presentation condition of the haptic media, the other media including media whose media type is a non-haptic type.

The presentation condition may include simultaneous presentation and condition trigger presentation. Simultaneous presentation means that the haptic media and other media on which the haptic media depends are simultaneously presented. Condition trigger presentation means that presentation of the haptic media is triggered only when the other media satisfies a trigger condition. The trigger condition may include a particular object, a particular spatial region, a particular event, a particular viewing angle, a particular sphere region, or a particular viewport. Correspondingly, the association relationship may include a dependency relationship between the haptic media and other media. Further, the association relationship may include a simultaneous presentation relationship and a condition trigger relationship.

S503: Generate relationship indication information based on the association relationship between the haptic media and the other media.

S504: Encapsulate the relationship indication information and the bitstream, to obtain a media file of the haptic media.

The encapsulating the relationship indication information and the bitstream, to obtain a media file of the haptic media may include the following two manners:

(1) The bitstream includes time-sequence haptic media.

In this case, the encapsulating the relationship indication information and the bitstream, to obtain a media file of the haptic media may include: encapsulating the bitstream as a haptic media track, where the haptic media track may include one or more samples, and any sample in the haptic media track may include one or more haptic signals of the time-sequence haptic media; and placing, by the service device, the relationship indication information at a sample entry of the haptic media track, to form the media file of the haptic media.

The association relationship includes a dependency relationship, the relationship indication information includes a presentation dependency flag, and the presentation dependency flag is used for indicating whether a sample in the haptic media track can be independently presented. The generating relationship indication information based on the association relationship between the haptic media and the other media may include: if determining, based on the association relationship between the haptic media and the other media, that the sample in the haptic media track can be independently presented, setting the presentation dependency flag to a second preset value; and if determining, based on the association relationship, that the sample in the haptic media track depends on other media during presentation, setting the presentation dependency flag to a first preset value.

In an embodiment, when the presentation dependency flag is set to the first preset value, the relationship indication information further includes reference indication information, and the reference indication information is configured for indicating an encapsulation position of the other media on which the sample in the haptic media track depends during presentation. In this case, the reference indication information may be represented as a track reference data box, the track reference data box is placed in the haptic media track, and the track reference data box is used for indexing to a track or a track group to which the other media on which the sample in the haptic media track depends during presentation belongs. The track reference data box includes a track identification field, and the track identification field is used for identifying the track or the track group to which the other media on which the sample in the haptic media track depends during presentation belongs.

In another embodiment, the relationship indication information may include a track reference data box, and if it is determined, based on the association relationship, that the sample in the haptic media track can be independently presented, it is determined that the haptic media track does not include the track reference data box. If it is determined, based on the association relationship, that the sample in the haptic media track depends on other media during presentation, it is determined that the haptic media track includes the track reference data box, and the track reference data box can be used for indexing to the track or the track group to which the other media on which the sample in the haptic media track depends during presentation belongs.

In an embodiment, the sample entry of the haptic media track further includes an encoder configuration record, and the encoder configuration record is used for indicating encoder limitation information of the sample in the haptic media track. The encoder configuration record includes a codec type field, a configuration identification field, and a level identification field. The codec type field is used for indicating a codec type of the sample in the haptic media track. When the sample in the haptic media track does not need to be encoded, the codec type field may be set to a second preset value. When the sample in the haptic media track needs to be decoded to obtain a haptic signal, the codec type field may be set to a first preset value. In this case, the codec type of the sample in the haptic media track is determined based on the codec type field. The configuration identification field is used for indicating a capability of an encoder required for encoding the haptic media, and a larger value of the configuration identification field indicates a higher capability of the encoder required for encoding the haptic media. The encoder supports encoding the haptic media of the codec type indicated by the codec type field; and the level identification field is used for indicating a capability level of the encoder. When the value of the codec type field is the second preset value, values of the configuration identification field and the level identification field are both the second preset value.

In some embodiments, the sample entry of the haptic media track may further include extended information, and the extended information may include a static dependency information field, a dependency information structure number field, and a dependency information structure field. The static dependency information field is used for indicating whether the haptic media track has static dependency information, the dependency information structure number field is used for indicating a number of pieces of dependency information on which the sample in the haptic media track depends during presentation; and the dependency information structure field is used for indicating content of dependency information on which the sample in the haptic media track depends during presentation, and the dependency information is valid for all samples in the haptic media track. When the haptic media track has static dependency information, a value of the static dependency information field is set to a first preset value. When the haptic media track has no static dependency information, a value of the static dependency information field is set to a second preset value.

In an embodiment, when dependency information on which the sample in the haptic media track depends dynamically changes with time, the dependency information on which the sample in the haptic media track depends during presentation may be indicated by using a metadata track. In this case, the relationship indication information includes a metadata track. The generating relationship indication information based on the association relationship between the haptic media and the other media includes: encapsulating the dependency information on which the sample in the haptic media track depends as the metadata track, where the metadata track includes one or more samples, any sample in the metadata track corresponds to one or more samples in the haptic media track, and any sample in the metadata track includes dependency information on which a corresponding sample in the haptic media track depends during presentation. A sample in the metadata track needs to be aligned in time with a corresponding sample in the haptic media track.

Further, the metadata track is associated with the haptic media track based on a track reference of a preset type. The metadata track includes a dependency information structure number field, a dependency information identification field, a dependency cancellation flag field, and a dependency information structure field; the dependency information structure number field is used for indicating a number of pieces of dependency information included by the sample in the metadata track; the dependency information identification field is used for indicating an identifier of current dependency information, and the current dependency information is dependency information on which a current sample that is being encoded in the haptic media track depends during presentation. The dependency cancellation flag field is used for indicating whether the current dependency information is valid. When the current dependency information is no longer valid, a value of the dependency cancellation flag field is set to a first preset value. When the current dependency information starts to become valid, a value of the dependency cancellation flag field is set to a second preset value, and the current dependency information keeps valid until the value of the dependency cancellation flag field is changed to the first preset value. The dependency information structure field is used for indicating content of the current dependency information.

(2) The bitstream includes non-time-sequence haptic media.

The encapsulating the relationship indication information and the bitstream, to obtain a media file of the haptic media may include: encapsulating the bitstream and the relationship indication information as a haptic media item, to form a media file of the haptic media. The haptic media item may include one or more haptic signals of non-time-sequence haptic media. The relationship indication information may include an entity group, and the association relationship includes a dependency relationship. In this case, the determining an association relationship between the haptic media and other media according to a presentation condition of the haptic media may include: generating an entity group based on the haptic media item and the other media having the dependency relationship with the haptic media item. The entity group includes one or more entities, the entity includes the haptic media item or other media, and the entity group is used for indicating a dependency relationship between a haptic media item in the entity group and other media in the entity group.

The entity group includes an entity group identification field, an entity number field, and an entity identification field; the entity group identification field is used for indicating an identifier of the entity group, and different entity groups have different identifiers; the entity number field is used for indicating a number of entities in the entity group; and the entity identification field is used for indicating an entity identifier in the entity group, the entity identifier is the same as an item identifier of an item to which an identified entity belongs, or the entity identifier is the same as a track identifier of a track to which the identified entity belongs, and different entities have different entity identifiers; where if the entity identifier indicated by the entity identification field is used for identifying a haptic media item in the entity group, the haptic media item in the entity group depends on other media in the entity group during presentation, and if the entity identifier indicated by the entity identification field is used for identifying other media in the entity group, presentation of the other media in the entity group affects presentation of a haptic media item in the entity group.

The haptic media item has one or more dependency properties, and the dependency property is used for indicating dependency information on which the haptic media item depends during presentation; the dependency property includes a dependency information structure number field and a dependency information structure field; the dependency information structure number field is used for indicating a number of pieces of dependency information on which the haptic media item depends during presentation; and the dependency information structure field is used for indicating content of dependency information on which the haptic media item depends during presentation.

In an embodiment, when the association relationship includes a dependency relationship, the association relationship may further include a simultaneous presentation relationship; and the dependency information structure field includes a presentation dependency flag field, and the presentation dependency flag field is used for indicating whether a current haptic media resource needs to be simultaneously presented with other media on which the current haptic media resource depends during presentation. When the current haptic media resource needs to be simultaneously presented with the other media on which the current haptic media resource depends during presentation, a value of the presentation dependency flag field is set to a first preset value. When the current haptic media resource does not need to be simultaneously presented with the other media on which the current haptic media resource depends during presentation, a value of the presentation dependency flag field is set to a second preset value. When the value of the presentation dependency flag field is set to the first preset value, the dependency information structure field includes a simultaneous dependency flag field. The simultaneous dependency flag field is used for indicating a media type on which the current haptic media resource simultaneously depends during presentation. When the current haptic media resource simultaneously depends on a plurality of media types during presentation, a value of the simultaneous dependency flag field is set to a first preset value. When the current haptic media resource depends, during presentation, on only any one of a plurality of media types to which the current haptic media resource refers, a value of the simultaneous dependency flag field is set to a second preset value.

In an embodiment, when the association relationship includes a dependency relationship, the association relationship further includes a condition trigger relationship, the condition trigger relationship indicates a trigger condition, and the trigger condition includes at least one of the following: a particular object, a particular spatial region, a particular event, a particular viewing angle, a particular sphere region, or a particular viewport, and the dependency information structure field includes an object dependency flag field, a spatial region dependency flag field, an event dependency flag field, a viewing angle dependency flag field, a sphere region dependency flag field, and a viewport dependency flag field.

The object dependency flag field is used for indicating whether a current haptic media resource depends on a particular object in other media during presentation. When the current haptic media resource depends on a particular object in the other media during presentation, a value of the object dependency flag field is set to a first preset value. In this case, the dependency information structure field further includes an object identification field, and the object identification field is used for indicating an identifier of the particular object on which the current haptic media resource depends during presentation. When the current haptic media resource does not depend on a particular object in the other media during presentation, a value of the object dependency flag field is set to a second preset value.

The spatial region dependency flag field is used for indicating whether the current haptic media resource depends on a particular spatial region in other media during presentation. When the current haptic media resource depends on a particular spatial region in other media during presentation, a value of the spatial region dependency flag field is set to a first preset value. In this case, the dependency information structure field further includes a spatial region structure field, and the spatial region structure field is used for representing information about the particular spatial region on which the current haptic media resource depends during presentation. When the current haptic media resource does not depend on a particular spatial region in other media during presentation, a value of the spatial region dependency flag field is set to a second preset value.

The event dependency flag field is used for indicating whether the current haptic media resource depends on a particular event in other media during presentation. When the current haptic media resource is triggered by a particular event in other media during presentation, a value of the event dependency flag field is set to a first preset value. In this case, the dependency information structure field further includes an event label field, and the event label field is used for indicating a label of the particular event on which the current haptic media resource depends during presentation. When the current haptic media resource does not depend on a particular event in the other media during presentation, a value of the event dependency flag field is set to a second preset value.

The viewing angle dependency flag field is used for indicating whether the current haptic media resource depends on a particular viewing angle during presentation. When a current haptic media resource depends on a particular viewing angle during presentation, a value of the viewing angle dependency flag field is set to a first preset value. In this case, the dependency information structure field further includes a viewing angle identification field, and the viewing angle identification field is used for indicating an identification of the particular viewing angle on which the current haptic media resource depends during presentation. When the current haptic media resource does not depend on a particular viewing angle during presentation, a value of the viewing angle dependency flag field is set to a second preset value.

The sphere region dependency flag field is used for indicating whether the current haptic media resource depends on a particular sphere region during presentation. When a current haptic media resource depends on a particular sphere region during presentation, a value of the sphere region dependency flag field is set to a first preset value. In this case, the dependency information structure field further includes a sphere region structure field, and the sphere region structure field is used for indicating information about the particular sphere region on which the current haptic media resource depends during presentation. When the current haptic media resource does not depend on a particular sphere region during presentation, a value of the sphere region dependency flag field is set to a second preset value.

The viewport dependency flag field is used for indicating whether the current haptic media resource depends on a particular viewport during presentation. When a current haptic media resource depends on a particular viewport during presentation, a value of the viewport dependency flag field is set to a first preset value. In this case, the dependency information structure field further includes a viewport identification field, and the viewport identification field is used for indicating an identification of the particular viewport on which the current haptic media resource depends during presentation. When the current haptic media resource does not depend on a particular viewport during presentation, a value of the viewport dependency flag field is set to a second preset value.

In an embodiment, the dependency information structure field includes a media type number field and a media type field; the media type number field is used for indicating a number of types of media on which the current haptic media resource simultaneously depends during presentation; and the media type field is used for indicating a media type of other media on which the current haptic media resource depends during presentation, and different values of the media type field indicate different types of media on which the current haptic media resource depends during presentation.

When a media type on which the current haptic media resource depends during presentation is two-dimensional video media, a value of the media type field is set to a first preset value. When a media type on which the current haptic media resource depends during presentation is audio media, a value of the media type field is set to a second preset value. When a media type on which the current haptic media resource depends during presentation is volumetric video media, a value of the media type field is set to a third preset value. When a media type on which the current haptic media resource depends during presentation is multi-viewing-angle video media, a value of the media type field is set to a fourth preset value. When a media type on which the current haptic media resource depends during presentation is subtitle media, a value of the media type field is set to a fifth preset value.

The current haptic media resource is haptic media that is being encoded in the bitstream, and the current haptic media resource includes any one or more of the following: a haptic media track, a haptic media item, and some samples in the haptic media track.

In an embodiment, after the relationship indication information and the bitstream are encapsulated, to obtain the media file of the haptic media, when the media file is transmitted in a streaming manner, the service device may generate description information of the relationship indication information, and transmit the media file of the haptic media through transmission signaling, where the transmission signaling includes the description information of the relationship indication information. The transmission signaling may be DASH signaling or MPD signaling.

The association relationship includes a dependency relationship; and the description information includes a preselected set, and the preselected set is used for defining the haptic media and the other media on which the haptic media depends indicated by the relationship indication information; and the preselected set includes an identifier list of a preselection component property, and the identifier list includes an adaption set corresponding to the haptic media and an adaption set corresponding to the other media, and if the media file includes a metadata track, the preselected set further includes an adaption set corresponding to the metadata track.

Each adaption set in the preselected set has a media type element field, the media type element field is used for indicating a media type of media corresponding to the adaption set, and a value of the media type element field is any one or more of the following: a sample entry type of a track to which media corresponding to an adaption set belongs, a handler type of a track to which media corresponding to an adaption set belongs, a type of an item to which media corresponding to an adaption set belongs, or a handler type of an item to which media corresponding to an adaption set belongs.

In an embodiment, the description information includes a dependency information descriptor, the dependency information descriptor is used for defining dependency information on which a haptic media resource depends during presentation, and the dependency information descriptor is used for describing a media resource of at least one of the following levels: a haptic media resource of a representation level, a haptic media resource of an adaption set level, or a haptic media resource of a preselection level; when the dependency information descriptor is used for describing a media resource of the adaption set level, all haptic media resources of the representation level in the media resource of the adaption set level depend on the same dependency information; when the dependency information descriptor is used for describing a media resource of the preselection level, all haptic media resources of the representation level in the media resource of the preselection level depend on the same dependency information; if the dependency information descriptor exists in the transmission signaling and the preselected set does not include the metadata track, the dependency information descriptor is valid for each sample corresponding to the described haptic media resource; and if the dependency information descriptor exists in the transmission signaling and the preselected set includes the metadata track, the dependency information descriptor is valid for some samples corresponding to the described haptic media resource, and the some samples are determined based on samples in the metadata track.

In this embodiment of this disclosure, haptic media is encoded, to obtain a bitstream of the haptic media; an association relationship between the haptic media and other media is determined according to a presentation condition of the haptic media, the other media including media whose media type is a non-haptic type; relationship indication information is generated based on the association relationship between the haptic media and the other media; and the relationship indication information and the bitstream are encapsulated, to obtain a media file of the haptic media. As can be known from the foregoing solutions, in the embodiments of this disclosure, an encoder side (a service device) may add the relationship indication information to the media file of the haptic media in the process of encoding the haptic media. In this way, the decoder side (the consumption device) can be effectively guided to accurately present the haptic media based on the association relationship between the haptic media and the other media indicated by the relationship indication information, thereby improving presentation accuracy of the haptic media and improving a presentation effect of the haptic media.

The data processing method for haptic media provided in this disclosure is described in detail below by using two complete examples:

### Example 1: Time-Sequence Haptic Media that Depends on Audio Media

1. The service device may obtain haptic media, where the haptic media includes time-sequence haptic media, and the time-sequence haptic media may include one or more haptic signals, and encode the haptic media, to obtain a bitstream of the haptic media.

2. The service device determines an association relationship between the haptic media and other media (for example, audio media) according to a presentation condition of the haptic media, where the association relationship includes that presentation of the haptic media depends on that of the audio media. In this case, the service device may generate relationship indication information based on the association relationship between the haptic media and the audio media. The service device encapsulates the haptic media as a haptic media track, where the haptic media track includes one or more samples, places the relationship indication information at a sample entry of the haptic media track (that is, Track1), to form a media file of the haptic media, and encapsulates the audio media as an audio media track (Track2), to form a media file of the audio media. The media file of the haptic media and the media file of the audio media may be the same media file. Certainly, the media file of the haptic media and the media file of the audio media may be different media files.

\textcircled{1} The relationship indication information includes an association relationship, and the relationship indication information includes a presentation dependency flag field. It is determined, based on the association relationship between the haptic media and the audio media, that the haptic media depends on other media during presentation, and the presentation dependency flag field is set to 1. The relationship indication information includes reference indication information, and the reference indication information is configured for indicating an encapsulation position of the audio media on which the sample in the haptic media track depends during presentation, that is, the encapsulation position of the audio media on which the sample depends is the audio media track. In this case, the reference indication information is represented as a track reference data box. The track reference data box is placed in the haptic media track (Track1), and the track reference data box is used for indexing to a track (that is, Track2) to which the audio media on which the sample in the haptic media track depends during presentation belongs. In this case, the relationship indication information is as follows:

Track1: haptics_dependency_flag=1; track_reference_type=“ahrf”; refer_track_id=2; and the track reference data box includes haptics_dependency_flag, track_reference_type, and refer_track_id; where haptics_dependency_flag=1 indicates that the haptic media depends on the audio media during presentation; track_reference_type=“ahrf” indicates that a reference track type is “ahrf”; and refer_track_id=2 is used for indicating that the track to which the audio media on which the sample in the haptic media track depends during presentation belongs is Track2.

Track2: audio.

\textcircled{2} Further, the association relationship includes a simultaneous presentation relationship, and some samples in the haptic media track and samples in a metadata track are simultaneously presented in a specific presentation time. In this case, the relationship indication information includes the metadata track. The relationship indication information is as follows:

Track1: haptics_dependency_flag=1; track_reference_type=“ahrf”; refer_track_id=2; and static_haptics_dependency_info=0; where static_haptics_dependency_info=0 indicates that a haptic media track has no static dependency information.

Track2: audio.

Track3: HapticsDependencyInfo metadata track: the metadata track includes: track_reference_type=“cdsc”; and refer_track_id=1. The metadata track further includes a dependency information structure field HapticsDependencyInfoStruct. A sample in track3 includes specific dependency information that changes with time, track_reference_type=“cdsc” indicates that the metadata track is associated with the haptic media track based on a track reference of “cdsc”, and refer_track_id=1 indicates that the haptic media track associated with the metadata track is Track1. A sample in track3 includes dependency information (that is, audio media) on which a sample in the haptic media track depends during presentation. A sample in track3 corresponds to one or more samples in the haptic media track, and a sample in the metadata track is aligned in time with a corresponding sample in the haptic media track. In addition, validity and invalidity of dependency information included in a sample in the metadata track are determined based on dependency_info_id[i] and dependency_cancel_flag[i] of the sample.

HapticsDependencyInfoStruct: presentation_dependency_flag=1; simultaneous_dependency_flag=0; and all other fields in the dependency information structure field are 0. presentation_dependency_flag=1 indicates that a sample in the haptic media track needs to be simultaneously presented with audio media on which the sample in the haptic media track depends during presentation. simultaneous_dependency_flag=0 indicates that a sample in the haptic media track depends, during presentation, on only any media type (that is, audio media) to which the sample refers.

3. The service device transmits the media file including the haptic media track and the audio media track to a consumption device. The transmission herein includes the following two manners:

(1) The service device may directly transmit an entire media file F to the consumption device, where the media file includes the media file of the haptic media track and the media file of the audio media track.

(2) The service device may transmit one or more segments Fs of the media file to the consumption device in a streaming manner. In this case, during streaming transmission, the service device may generate description information of the relationship indication information, and send the description information of the relationship indication information to the consumption device through transmission signaling. The consumption device may determine a dependency relationship between the haptic media and other media according to the description information of the relationship indication information, and then obtain the haptic media and the other media according to the transmission signaling. In this embodiment, it may be determined, based on the preselected set and the dependency information descriptor that are included in the description information, that the haptic media depends on the audio media, and the preselected set includes the metadata track. Therefore, the consumption device needs to obtain a haptic media resource, an audio media resource, and a metadata resource through the transmission signaling. Specifically, the media file of the haptic media, the media file of the audio media, and the media file of the metadata track may be obtained through the transmission signaling. The description information of the relationship indication information is as follows:

Preselection@preselectionComponents: AdaptationSet1 (track1), AdaptationSet2 (track2), AdaptationSet3 (track3); Preselection@preselectionComponents@codecs=“ahap”. AdaptationSet1 is an adaption set corresponding to track1, AdaptationSet2 is an adaption set corresponding to track2, AdaptationSet3 is an adaption set corresponding to track3, and Preselection@ PreselectionComponents@codecs=“ahap” indicates that a codec property of the preselected set is “ahap”, and indicates that media in the preselected set is haptic media and audio media on which the haptic media depends during presentation.

AdaptationSet1@mediaType=“ahap”; AdaptationSet2@mediaType=“soun”; AdaptationSet3@mediaType=“ahdm”; AdaptationSet1@mediaType=“ahap” indicates that a media type of media corresponding to AdaptationSet1 is “ahap”;

AdaptationSet2@mediaType=“soun” indicates that a media type of media corresponding to AdaptationSet2 is “soun”; and AdaptationSet3@mediaType=“ahdm” indicates that a media type of media corresponding to AdaptationSet3 is “ahdm”.

AdaptationSet1 has a dependency information descriptor AVSHapticsDependencyInfo: The dependency information descriptor includes the following element fields: AVSHapticsDependencyInfo@presentation_dependency_flag=1; and @ simultaneous_dependency_flag=0. Values of other element fields in the dependency information descriptor are all 0.

AVSHapticsDependencyInfo@presentation_dependency_flag=1 indicates that a sample in the haptic media track needs to be simultaneously presented with audio media on which the sample in the haptic media track depends during presentation. @ simultaneous_dependency_flag=0 indicates that a sample in the haptic media track depends, during presentation, on only any media type (that is, audio media) to which the sample refers.

4. The consumption device decapsulates the media file F or the segments Fs of the media file, to obtain the haptic media track, the audio media track, and the metadata track. By parsing the metadata track, it is determined that presentation of a sample in the haptic media track depends on presentation of the audio media at a specific presentation time.

5. The consumption device may decode the sample in the haptic media track and decode the audio media in the audio media track, and simultaneously present the haptic media and the audio media at a specific presentation time.

### Example 2: Non-Time-Sequence Haptic Media that Depends on Audio

1. The service device may obtain haptic media, where the haptic media may include non-time-sequence haptic media, and the non-time-sequence haptic media includes one or more haptic signals, and the service device may encode the non-time-sequence haptic media, to obtain a bitstream of the haptic media.

2. The service device determines an association relationship between the haptic media and other media (for example, audio media) according to a presentation condition of the haptic media, and generates relationship indication information based on the association relationship between the haptic media and the audio media. The service device encapsulates the relationship indication information and the haptic media as a haptic media item, to form a media file of the haptic media; and encapsulates the audio media as an audio media track, to form a media file of the audio media. The media file of the haptic media and the media file of the audio media may be the same media file, or certainly may be different media files.

\textcircled{1} The association relationship includes a dependency relationship, and an entity group may be generated for the haptic media item and the audio media track according to the dependency relationship between the haptic media and the audio media. In this case, the relationship indication information includes the entity group, and the entity group is used for indicating a dependency relationship between the haptic media item in the entity group and the audio media track in the entity group. Syntax of the entity group is as follows:
Entity ToGroupBox (‘ahde’):
group_id=1;
num_entities_in_group=2;
entity_id: 1,2;
Item1: type ahai, that is, haptics;
Track2: audio.

group_id=1 indicates that an identifier of the entity group is 1, and num_entities_in_group=2 indicates that a number of entities of the entity group is 2; and entity_id: 1,2 indicates that entity identifiers in the entity group are respectively 1 and 2. The entity identifier 2 in the entity group is the same as a track identifier of an audio media track to which an entity identified by the entity identifier belongs. The entity identifier 1 in the entity group is the same as an item identifier of an item (that is, Item1) to which an entity identified by the entity identifier belongs. The non-time-sequence haptic media is encapsulated as Item1 of a preset type ahai in the media file. Track2 is an audio media track.

\textcircled{2} Further, the association relationship includes a condition trigger relationship. In this case, Item1 corresponds to a dependency property HapticsDependencyInfoProperty. HapticsDependencyInfoProperty includes a dependency information structure field HapticsDependency InfoStruct. HapticsDependencyInfoStruct: event_dependency_flag=1; event_label=“ending drum”; and values of the remaining fields in the HapticsDependency InfoStruct are all 0. event_dependency_flag=1 indicates that the haptic media item depends on a particular event in other media during presentation. event_label=“ending drum” indicates that a label of the particular event on which the haptic media item depends during presentation is ending drum.

3. The service device may transmit a media file F including the haptic media item and the audio media track to the consumption device. The media file F may be transmitted to the consumption device in the following two manners:

(1) The service device may directly transmit the entire media file F to the client.

(2) The service device may transmit one or more segments Fs of the media file to the consumption device in a streaming manner. During streaming transmission, the service device may generate description information of the relationship indication information, and send the description information of the relationship indication information to the consumption device through transmission signaling. The consumption device may determine a dependency relationship between the haptic media and audio media according to the description information of the relationship indication information, and then obtain the haptic media and the audio media according to the transmission signaling. In this embodiment, it may be determined, based on the preselected set and the dependency information descriptor that are included in the description information, that the haptic media depends on the audio media, and the preselected set does not include the metadata track. Therefore, the haptic media item and the audio media track need to be obtained through the transmission signaling. The description information of the relationship indication information is as follows:

Preselection@preselectionComponents: AdaptationSet1 (item1), AdaptationSet2 (track2). AdaptationSet1 is an adaption set corresponding to item 1, and AdaptationSet2 is an adaption set corresponding to track2.

AdaptationSet1@mediaType=“ahap”; and AdaptationSet2@mediaType=“soun”. AdaptationSet1@mediaType=“ahap” indicates that a media type of media corresponding to AdaptationSet1 is “ahap”; and AdaptationSet2@mediaType=“soun” indicates that a media type of media corresponding to AdaptationSet2 is “soun”.

AdaptationSet1 has a dependency information descriptor AVSHapticsDependencyInfo. The dependency information descriptor is: AVSHapticsDependencyInfo@ event_dependency_flag=1; @ event_label=“ending drum”; and values of other elements in the dependency information descriptor are all 0. AVSHapticsDependencyInfo@ event_dependency_flag=1 indicates that the haptic media item depends on a particular event in other media (that is, audio media) during presentation. @ event_label=“ending drum” indicates that a label of the particular event on which the haptic media item depends during presentation is ending drum.

4. The consumption device decapsulates the media file F or the segments Fs of the media file, to obtain the haptic media item and the audio media track. Then, the relationship indication information is obtained from the media file F or the segments Fs of the media file, or the relationship indication information may be obtained according to the description information of the relationship indication information. It may be determined, according to the relationship indication information, that a presentation condition of the haptic media item is triggered by a particular event, and then the consumption device may decode the dependency property HapticsDependency InfoProperty to obtain a label of the predefined particular event, and determine that presentation of the haptic media is triggered at an end moment of a music drum in the audio media.

5. The consumption device may first present the audio media obtained through decoding, and when the music drum in the audio media ends, present the haptic media obtained through decoding.

The foregoing two embodiments are exemplary manners provided in this disclosure, and may be flexibly selected for use or combined for use according to an association relationship between haptic media and other media based on an actual case. This is not limited in this disclosure.

In this embodiment of this disclosure, the service device may obtain the presentation condition of the haptic media, determine the association relationship between the haptic media and other media based on the presentation condition, generate the relationship indication information based on the association relationship between the haptic media and the other media, and encapsulate the relationship indication information and the bitstream, to obtain the media file of the haptic media. The consumption device may receive the media file of the haptic media, and decode the bitstream based on the association relationship indicated by the relationship indication information in the media file, to present the haptic media. In the embodiments of this disclosure, an encoder side (a service device) may add the relationship indication information to the media file of the haptic media in the process of encoding the haptic media. In this way, the decoder side (the consumption device) can be effectively guided to accurately present the haptic media based on the association relationship between the haptic media and the other media indicated by the relationship indication information, thereby improving presentation accuracy of the haptic media and improving a presentation effect of the haptic media.

Next, a data processing apparatus for haptic media related to the embodiments of this disclosure is described.

FIG. 6 is a schematic structural diagram of a data processing apparatus for haptic media according to an embodiment of this disclosure. The data processing apparatus for haptic media may be disposed in a computer device according to the embodiments of this disclosure, and the computer device may be the consumption device in the foregoing method embodiments. The data processing apparatus for haptic media shown in FIG. 6 may be a computer program (including program code) running in a computer device, and the data processing apparatus for haptic media may be configured to perform some or all of the operations of the method embodiment shown in FIG. 3. Referring to FIG. 6, the data processing apparatus for haptic media may include the following units:
an obtaining unit 601, configured to obtain a media file of haptic media, the media file including a bitstream and relationship indication information of the haptic media, the relationship indication information being configured for indicating an association relationship between the haptic media and other media, and the other media including media whose media type is a non-haptic type; and
a processing unit 602, configured to decode the bitstream according to the relationship indication information, to present the haptic media.

In an embodiment, the haptic media includes time-sequence haptic media. The time-sequence haptic media is encapsulated as a haptic media track in the media file, the haptic media track includes one or more samples, and any sample in the haptic media track includes one or more haptic signals of the time-sequence haptic media; and the relationship indication information is placed at a sample entry of the haptic media track; the association relationship includes a dependency relationship; and the relationship indication information includes a presentation dependency flag, and the presentation dependency flag is used for indicating whether a sample in the haptic media track can be independently presented.

When the presentation dependency flag is a second preset value, the sample in the haptic media track can be independently presented; and when the presentation dependency flag is a first preset value, the sample in the haptic media track depends on other media during presentation.

When the presentation dependency flag is the first preset value, the relationship indication information further includes reference indication information, and the reference indication information is configured for indicating an encapsulation position of the other media on which the sample in the haptic media track depends during presentation.

In an embodiment, the reference indication information is represented as a track reference data box, the track reference data box is placed in the haptic media track, and the track reference data box is used for indexing to a track or a track group to which the other media on which the sample in the haptic media track depends during presentation belongs.

The track reference data box includes a track identification field, and the track identification field is used for identifying the track or the track group to which the other media on which the sample in the haptic media track depends during presentation belongs.

In an embodiment, the haptic media includes time-sequence haptic media. The time-sequence haptic media is encapsulated as a haptic media track in the media file, the haptic media track includes one or more samples, and any sample in the haptic media track includes one or more haptic signals of the time-sequence haptic media; and the association relationship includes a dependency relationship; and the relationship indication information includes a track reference data box.

If the track reference data box is not included in the haptic media track, the sample in the haptic media track can be independently presented; and if the track reference data box is included in the haptic media track, the sample in the haptic media track depends on other media during presentation, and the track reference data box can be used for indexing to the track or the track group to which the other media on which the sample in the haptic media track depends during presentation belongs.

In an embodiment, the sample entry of the haptic media track further includes a decoder configuration record, and the decoder configuration record is used for indicating decoder limitation information of the sample in the haptic media track.

The decoder configuration record includes a codec type field, a configuration identification field, and a level identification field.

The codec type field is used for indicating a codec type of the sample in the haptic media track, when the codec type field is a second preset value, the sample in the haptic media track does not need to be decoded, and when the codec type field is a first preset value, the sample in the haptic media track needs to be decoded to obtain a haptic signal, and the codec type of the sample in the haptic media track is determined based on the codec type field.

The configuration identification field is used for indicating a capability of a decoder required for parsing the haptic media, and a larger value of the configuration identification field indicates a higher capability of the decoder required for parsing the haptic media, and the decoder supports parsing the haptic media of the codec type indicated by the codec type field.

The level identification field is used for indicating a capability level of the decoder.

When the value of the codec type field is the second preset value, values of the configuration identification field and the level identification field are both the second preset value.

In an embodiment, the sample entry of the haptic media track further includes extended information, and the extended information includes a static dependency information field, a dependency information structure number field, and a dependency information structure field.

The static dependency information field is used for indicating whether the haptic media track has static dependency information, when a value of the static dependency information field is a first preset value, the haptic media track has static dependency information, and when a value of the static dependency information field is a second preset value, the haptic media track has no static dependency information.

The dependency information structure number field is used for indicating a number of pieces of dependency information on which the sample in the haptic media track depends during presentation.

The dependency information structure field is used for indicating content of dependency information on which the sample in the haptic media track depends during presentation, and the dependency information is valid for all samples in the haptic media track.

In an embodiment, the haptic media includes time-sequence haptic media. The time-sequence haptic media is encapsulated as a haptic media track in the media file, the haptic media track includes one or more samples, and any sample in the haptic media track includes one or more haptic signals of the time-sequence haptic media.

The relationship indication information includes a metadata track, and the metadata track is used for indicating dependency information on which the sample in the haptic media track depends during presentation, and is used for indicating a dynamic temporal change of the dependency information on which the sample in the haptic media track depends during presentation.

The metadata track includes one or more samples, any sample in the metadata track corresponds to one or more samples in the haptic media track, any sample in the metadata track includes dependency information on which a corresponding sample in the haptic media track depends during presentation, a sample in the metadata track needs to be aligned in time with a corresponding sample in the haptic media track, and the metadata track is associated with the haptic media track based on a track reference of a preset type.

In an embodiment, the metadata track includes a dependency information structure number field, a dependency information identification field, a dependency cancellation flag field, and a dependency information structure field.

The dependency information structure number field is used for indicating a number of pieces of dependency information included by the sample in the metadata track.

The dependency information identification field is used for indicating an identifier of current dependency information, and the current dependency information is dependency information on which a current sample that is being decoded in the haptic media track depends during presentation.

The dependency cancellation flag field is used for indicating whether the current dependency information is valid, when a value of the dependency cancellation flag field is a first preset value, the current dependency information is no longer valid, and when a value of the dependency cancellation flag field is a second preset value, the current dependency information starts to become valid, and the current dependency information keeps valid until the value of the dependency cancellation flag field is changed to the first preset value.

The dependency information structure field is used for indicating content of the current dependency information.

In an embodiment, the haptic media includes non-time-sequence haptic media. The non-time-sequence haptic media is encapsulated as a haptic media item in the media file, and one haptic media item includes one or more haptic signals of the non-time-sequence haptic media.

The relationship indication information includes an entity group, the entity group includes one or more entities, the entity includes the haptic media item or other media, and the entity group is used for indicating a dependency relationship between a haptic media item in the entity group and other media in the entity group.

The entity group includes an entity group identification field, an entity number field, and an entity identification field.

The entity group identification field is used for indicating an identifier of the entity group, and different entity groups have different identifiers.

The entity number field is used for indicating a number of entities in the entity group.

The entity identification field is used for indicating an entity identifier in the entity group, the entity identifier is the same as an item identifier of an item to which an identified entity belongs, or the entity identifier is the same as a track identifier of a track to which the identified entity belongs, and different entities have different entity identifiers.

If the entity identifier indicated by the entity identification field is used for identifying a haptic media item in the entity group, the haptic media item in the entity group depends on other media in the entity group during presentation, and if the entity identifier indicated by the entity identification field is used for identifying other media in the entity group, presentation of the other media in the entity group affects presentation of a haptic media item in the entity group.

In an embodiment, the haptic media item has one or more dependency properties, and the dependency property is used for indicating dependency information on which the haptic media item depends during presentation.

The dependency property includes a dependency information structure number field and a dependency information structure field.

The dependency information structure number field is used for indicating a number of pieces of dependency information on which the haptic media item depends during presentation.

The dependency information structure field is used for indicating content of dependency information on which the haptic media item depends during presentation.

In an embodiment, the association relationship includes a simultaneous presentation relationship; and the dependency information structure field includes a presentation dependency flag field.

The presentation dependency flag field is used for indicating whether a current haptic media resource needs to be simultaneously presented with other media on which the current haptic media resource depends during presentation, when a value of the presentation dependency flag field is a first preset value, the current haptic media resource needs to be simultaneously presented with the other media on which the current haptic media resource depends during presentation, and when a value of the presentation dependency flag field is a second preset value, the current haptic media resource does not need to be simultaneously presented with the other media on which the current haptic media resource depends during presentation.

When the value of the presentation dependency flag field is the first preset value, the dependency information structure field includes a simultaneous dependency flag field, the simultaneous dependency flag field is used for indicating a media type on which the current haptic media resource simultaneously depends during presentation, when a value of the simultaneous dependency flag field is a first preset value, the current haptic media resource simultaneously depends on a plurality of media types during presentation, and when a value of the simultaneous dependency flag field is a second preset value, the current haptic media resource depends, during presentation, on only any one of a plurality of media types to which the current haptic media resource refers.

The current haptic media resource is haptic media that is being decoded in the bitstream, and the current haptic media resource includes any one or more of the following: a haptic media track, a haptic media item, and some samples in the haptic media track.

In an embodiment, the association relationship includes a condition trigger relationship, the condition trigger relationship indicates a trigger condition, the trigger condition includes at least one of the following: a particular object, a particular spatial region, a particular event, a particular viewing angle, a particular sphere region, or a particular viewport, and the dependency information structure field includes an object dependency flag field, a spatial region dependency flag field, an event dependency flag field, a viewing angle dependency flag field, a sphere region dependency flag field, and a viewport dependency flag field.

The object dependency flag field is used for indicating whether a current haptic media resource depends on a particular object in other media during presentation. When a value of the object dependency flag field is a first preset value, the current haptic media resource depends on a particular object in the other media during presentation. In this case, the dependency information structure field further includes an object identification field, and the object identification field is used for indicating an identifier of the particular object on which the current haptic media resource depends during presentation. When a value of the object dependency flag field is a second preset value, the current haptic media resource does not depend on a particular object in the other media during presentation.

The spatial region dependency flag field is used for indicating whether the current haptic media resource depends on a particular spatial region in other media during presentation. When a value of the spatial region dependency flag field is a first preset value, the current haptic media resource depends on a particular spatial region in the other media during presentation. In this case, the dependency information structure field further includes a spatial region structure field, and the spatial region structure field is used for indicating information about the particular spatial region on which the current haptic media resource depends during presentation. When a value of the spatial region dependency flag field is a second preset value, the current haptic media resource does not depend on a particular spatial region in the other media during presentation.

The event dependency flag field is used for indicating whether the current haptic media resource depends on a particular event in other media during presentation. When a value of the event dependency flag field is a first preset value, the current haptic media resource is triggered by a particular event in the other media during presentation. In this case, the dependency information structure field further includes an event label field, and the event label field is used for indicating a label of the particular event on which the current haptic media resource depends during presentation. When a value of the event dependency flag field is a second preset value, the current haptic media resource does not depend on a particular event in the other media during presentation.

The viewing angle dependency flag field is used for indicating whether the current haptic media resource depends on a particular viewing angle during presentation. When a value of the viewing angle dependency flag field is a first preset value, the current haptic media resource depends on a particular viewing angle during presentation. In this case, the dependency information structure field further includes a viewing angle identification field, and the viewing angle identification field is used for indicating an identifier of the particular viewing angle on which the current haptic media resource depends during presentation. When a value of the viewing angle dependency flag field is a second preset value, the current haptic media resource does not depend on a particular viewing angle during presentation.

The sphere region dependency flag field is used for indicating whether the current haptic media resource depends on a particular sphere region during presentation. When a value of the sphere region dependency flag field is a first preset value, the current haptic media resource depends on a particular sphere region during presentation. In this case, the dependency information structure field further includes a sphere region structure field, and the sphere region structure field is used for indicating information about the particular sphere region on which the current haptic media resource depends during presentation. When a value of the sphere region dependency flag field is a second preset value, the current haptic media resource does not depend on a particular sphere region during presentation.

The viewport dependency flag field is used for indicating whether the current haptic media resource depends on a particular viewport during presentation. When a value of the viewport dependency flag field is a first preset value, the current haptic media resource depends on a particular viewport during presentation. In this case, the dependency information structure field further includes a viewport identification field, and the viewport identification field is used for indicating an identifier of the particular viewport on which the current haptic media resource depends during presentation. When a value of the viewport dependency flag field is a second preset value, the current haptic media resource does not depend on a particular viewport during presentation.

In an embodiment, the dependency information structure field includes a media type number field and a media type field.

The media type number field is used for indicating a number of types of media on which the current haptic media resource simultaneously depends during presentation.

The media type field is used for indicating a media type of other media on which the current haptic media resource depends during presentation, and different values of the media type field indicate different types of media on which the current haptic media resource depends during presentation.

When a value of the media type field is a first preset value, a media type on which the current haptic media resource depends during presentation is two-dimensional video media; when a value of the media type field is a second preset value, a media type on which the current haptic media resource depends during presentation is audio media; when a value of the media type field is a third preset value, a media type on which the current haptic media resource depends during presentation is volumetric video media; when a value of the media type field is a fourth preset value, a media type on which the current haptic media resource depends during presentation is multi-viewing-angle video media; and when a value of the media type field is a fifth preset value, a media type on which the current haptic media resource depends during presentation is subtitle media.

In an embodiment, the haptic media is transmitted in a streaming manner, and the processing unit 602 is specifically configured to:
obtain transmission signaling of the haptic media, where the transmission signaling includes description information of the relationship indication information; and
obtain the media file of the haptic media according to the transmission signaling.

In an embodiment, the association relationship includes a dependency relationship; and the description information includes a preselected set, and the preselected set is used for defining the haptic media and the other media on which the haptic media depends indicated by the relationship indication information.

The preselected set includes an identifier list of a preselection component property, and the identifier list includes an adaption set corresponding to the haptic media and an adaption set corresponding to the other media, and if the media file includes a metadata track, the preselected set further includes an adaption set corresponding to the metadata track.

Each adaption set in the preselected set has a media type element field, the media type element field is used for indicating a media type of media corresponding to the adaption set, and a value of the media type element field is any one or more of the following: a sample entry type of a track to which media corresponding to an adaption set belongs, a handler type of a track to which media corresponding to an adaption set belongs, a type of an item to which media corresponding to an adaption set belongs, or a handler type of an item to which media corresponding to an adaption set belongs.

In an embodiment, the description information includes a dependency information descriptor, the dependency information descriptor is used for defining dependency information on which a haptic media resource depends during presentation, and the dependency information descriptor is used for describing a media resource of at least one of the following levels: a haptic media resource of a representation level, a haptic media resource of an adaption set level, or a haptic media resource of a preselection level.

When the dependency information descriptor is used for describing a media resource of the adaption set level, all haptic media resources of the representation level in the media resource of the adaption set level depend on the same dependency information.

When the dependency information descriptor is used for describing a media resource of the preselection level, all haptic media resources of the representation level in the media resource of the preselection level depend on the same dependency information.

If the dependency information descriptor exists in the transmission signaling and the preselected set does not include the metadata track, the dependency information descriptor is valid for each sample corresponding to the described haptic media resource.

If the dependency information descriptor exists in the transmission signaling and the preselected set includes the metadata track, the dependency information descriptor is valid for some samples corresponding to the described haptic media resource, and the some samples are determined based on samples in the metadata track.

In an embodiment, the processing unit 602 is specifically configured to:

obtain, based on the association relationship indicated by the relationship indication information, the other media associated with the haptic media;

decode the haptic media and the other media; and

present the other media and the haptic media based on the association relationship; where

the other media includes any one or more of the following: two-dimensional video media, audio media, volumetric video media, multi-viewing-angle video media, and subtitle media.

In this embodiment of this disclosure, a decoder side (a consumption device) of the haptic media may obtain the media file of the haptic media, the media file including a bitstream and relationship indication information of the haptic media, and the relationship indication information being configured for indicating an association relationship between the haptic media and other media (including media whose media type is a non-haptic type), and decode the bitstream according to the relationship indication information, to present the haptic media. As can be known from the foregoing solutions, in the embodiments of this disclosure, an encoder side (a service device) may add the relationship indication information to the media file of the haptic media in the process of encoding the haptic media. In this way, the decoder side (the consumption device) can be effectively guided to accurately present the haptic media based on the association relationship between the haptic media and the other media indicated by the relationship indication information, thereby improving presentation accuracy of the haptic media and improving a presentation effect of the haptic media.

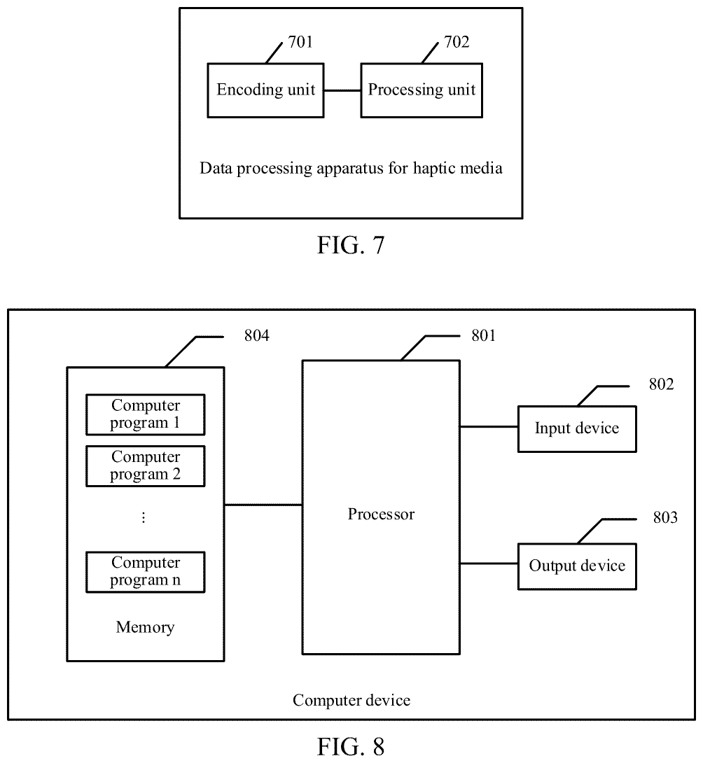

FIG. 7 is a schematic structural diagram of a data processing apparatus for haptic media according to an embodiment of this disclosure. The data processing apparatus for haptic media may be disposed in a computer device according to the embodiments of this disclosure, and the computer device may be the service device in the foregoing method embodiments. The data processing apparatus for haptic media shown in FIG. 7 may be a computer program (including program code) running in a computer device, and the data processing apparatus for haptic media may be configured to perform some or all of the operations of the method embodiment shown in FIG. 5. Referring to FIG. 7, the data processing apparatus for haptic media may include the following units:

an encoding unit 701, configured to encode haptic media, to obtain a bitstream of the haptic media; and

a processing unit 702, configured to determine an association relationship between the haptic media and other media according to a presentation condition of the haptic media, the other media including media whose media type is a non-haptic type;
the processing unit 702 being further configured to generate relationship indication information based on the association relationship between the haptic media and the other media; and
the processing unit 702 being further configured to encapsulate the relationship indication information and the bitstream, to obtain a media file of the haptic media.

In this embodiment of this disclosure, haptic media is encoded, to obtain a bitstream of the haptic media; an association relationship between the haptic media and other media is determined according to a presentation condition of the haptic media, the other media including media whose media type is a non-haptic type; relationship indication information is generated based on the association relationship between the haptic media and the other media; and the relationship indication information and the bitstream are encapsulated, to obtain a media file of the haptic media. As can be known from the foregoing solutions, in this embodiment of this disclosure, an encoder side (a service device) may add the relationship indication information to the media file of the haptic media in the process of encoding the haptic media. In this way, a decoder side (a consumption device) can be effectively guided to accurately present the haptic media based on the association relationship between the haptic media and the other media indicated by the relationship indication information, thereby improving presentation accuracy of the haptic media and improving a presentation effect of the haptic media.

Next, a consumption device and a service device provided in the embodiments of this disclosure are described.

Further, an embodiment of this disclosure further provides a schematic structural diagram of a computer device. The schematic structural diagram of the computer device can be shown in FIG. 8. The computer device may include: a processor 801, an input device 802, an output device 803, and a memory 804. The processor 801, the input device 802, the output device 803, and the memory 804 are connected through a bus. The memory 804 is configured to store a computer program that include program instructions, and the processor 801 is configured to execute the program instructions stored in the memory 804.

In an embodiment, the computer device may be the foregoing consumption device. In this embodiment, the processor 801 performs the following operations by running the executable program code in the memory 804:

obtaining a media file of haptic media, the media file including a bitstream and relationship indication information of the haptic media, the relationship indication information being configured for indicating an association relationship between the haptic media and other media, and the other media including media whose media type is a non-haptic type; and

decoding the bitstream according to the relationship indication information, to present the haptic media.

During specific implementation, the computer device (the consumption device) in this embodiment may perform, by using a computer program built therein, the implementations provided by the operations in FIG. 3. For details, refer to the implementations provided by the operations, and details are not described herein again.

In this embodiment of this disclosure, a consumption device may obtain the media file of the haptic media, the media file including a bitstream and relationship indication information of the haptic media, and the relationship indication information being configured for indicating an association relationship between the haptic media and other media (including media whose media type is a non-haptic type), and decode the bitstream according to the relationship indication information, to present the haptic media. In this embodiment of this disclosure, an encoder side (a service device) may add the relationship indication information to the media file of the haptic media in the process of encoding the haptic media. In this way, a decoder side (a consumption device) can be effectively guided to accurately present the haptic media based on the association relationship between the haptic media and the other media indicated by the relationship indication information, thereby improving presentation accuracy of the haptic media and improving a presentation effect of the haptic media.

In another embodiment, the computer device may be the foregoing service device. In this embodiment, the processor 801 performs the following operations by running the executable program code in the memory 804:
encoding haptic media, to obtain a bitstream of the haptic media;
determining an association relationship between the haptic media and other media according to a presentation condition of the haptic media, the other media including media whose media type is a non-haptic type;

generating relationship indication information based on the association relationship between the haptic media and the other media; and

encapsulating the relationship indication information and the bitstream, to obtain a media file of the haptic media.

During specific implementation, the computer device (the service device) in this embodiment may perform, by using a computer program built therein, the implementations provided by the operations in FIG. 5. For details, refer to the implementations provided by the operations, and details are not described herein again.

In this embodiment of this disclosure, haptic media is encoded, to obtain a bitstream of the haptic media; an association relationship between the haptic media and other media is determined according to a presentation condition of the haptic media, the other media including media whose media type is a non-haptic type; relationship indication information is generated based on the association relationship between the haptic media and the other media; and the relationship indication information and the bitstream are encapsulated, to obtain a media file of the haptic media. As can be known from the foregoing solutions, in this embodiment of this disclosure, an encoder side (a service device) may add the relationship indication information to the media file of the haptic media in the process of encoding the haptic media. In this way, a decoder side (a consumption device) can be effectively guided to accurately present the haptic media based on the association relationship between the haptic media and the other media indicated by the relationship indication information, thereby improving presentation accuracy of the haptic media and improving a presentation effect of the haptic media.

In addition, an embodiment of this disclosure further provides a computer-readable storage medium. The computer-readable storage medium stores a computer program The computer program includes program instructions. When executing the program instructions, a processor can perform the method in the foregoing embodiments corresponding to FIG. 3 and FIG. 5. Therefore, details are not repeated herein. For technical details that are not disclosed in the embodiment of the computer-readable storage medium of this disclosure, refer to the descriptions of the method embodiments of this disclosure. In an example, the program instructions may be deployed to be executed on a computer device, or deployed to be executed on a plurality of computer devices at the same location, or deployed to be executed on a plurality of computer devices that are distributed in a plurality of locations and interconnected by using a communication network.

According to an aspect of this disclosure, a computer program product is provided, where the computer program product includes a computer program, and the computer program is stored in a computer-readable storage medium. A processor of a computer device reads the computer program from the computer-readable storage medium, and the processor executes the computer program, so that the computer device executes the methods in the embodiments corresponding to FIG. 3 and FIG. 5. Therefore, details are not described herein again.

A person of ordinary skill in the art may understand that all or some of the procedures of the methods of the foregoing embodiments may be implemented by a computer program instructing relevant hardware. The program may be stored in a computer-readable storage medium. When the program is executed, the procedures of the foregoing method embodiments may be implemented. The foregoing storage medium may include a magnetic disc, an optical disc, a read-only memory (ROM), a random access memory (RAM), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The content disclosed above is merely examples of embodiments of this disclosure, but are not intended to limit the scope of this disclosure. A person of ordinary skill in the art can understand all or a part of the procedures for implementing the foregoing embodiments, and any equivalent variation made shall still fall within the scope of this disclosure.

What is claimed is:

1. A method of data processing, the method comprising:
obtaining a media file of haptic media, the media file comprising a first portion and a second portion, wherein the first portion includes a bitstream of media data of the haptic media and the second portion includes relationship indication information indicating an association relationship between the haptic media and at least a non-haptic media; and
decoding the bitstream according to the relationship indication information to obtain the media data for presenting the haptic media.

2. The method according to claim 1, wherein:
the haptic media comprises time-sequence haptic media that is encapsulated as a haptic media track in the media file;
the haptic media track comprises one or more samples that each comprises one or more haptic signals of the time-sequence haptic media;
the relationship indication information is placed at a sample entry of the haptic media track and includes a presentation dependency flag for indicating whether the one or more samples in the haptic media track are independently presented;
in response to that the presentation dependency flag is of a first preset value, the one or more samples in the haptic media track are to be presented depending on the non-haptic media, the relationship indication information comprising reference indication information indicating an encapsulation position of the non-haptic media that the one or more samples depend on; and
in response to that the presentation dependency flag is of a second preset value, the one or more samples in the haptic media track are to be independently presented.

3. The method according to claim 2, wherein:
the reference indication information is represented as a track reference data box;
the track reference data box is placed in the haptic media track, and is used for indexing to a track or a track group of the non-haptic media that the one or more samples in the haptic media track depends on during a presentation; and
the track reference data box comprises a track identification field for identifying the track or the track group.

4. The method according to claim 1, wherein:
the haptic media comprises time-sequence haptic media that is encapsulated as a haptic media track in the media file;
the haptic media track comprises one or more samples that each sample comprises one or more haptic signals of the time-sequence haptic media;
the relationship indication information comprises a track reference data box indicating a dependency relationship;
in response to that the track reference data box is not in the haptic media track, the one or more samples in the haptic media track are to be independently presented; and
in response to that the track reference data box is in the haptic media track, the one or more samples in the haptic media track depend on the non-haptic media during a presentation, and the track reference data box points to a track or track group of the non-haptic media that the one or more samples in the haptic media track depend on during the presentation.

5. The method according to claim 2, wherein:
the sample entry of the haptic media track further comprises a decoder configuration record that is configured to indicate decoder limitation information of the one or more samples in the haptic media track;
the decoder configuration record comprises a codec type field, a configuration identification field, and a level identification field;
the codec type field is configured to indicate a codec type of the one or more samples in the haptic media track;
the configuration identification field is configured to indicate a capability of a decoder for parsing the haptic media;
the level identification field is configured to indicate a capability level of the decoder; and
in response to that the codec type field is of a preset value indicating no decoding of the one or more samples, the configuration identification field and the level identification field are set to the preset value.

6. The method according to claim 2, wherein:
the sample entry of the haptic media track further comprises extended information that includes a static dependency information field, a dependency information structure number field, and a dependency information structure field;
the static dependency information field is configured to indicate whether the haptic media track has static dependency information;
the dependency information structure number field is configured to indicate a number of pieces of dependency information that the one or more samples in the haptic media track depends on during a presentation; and
the dependency information structure field is configured to indicate content of dependency information that the one or more samples in the haptic media track depend on during the presentation.

7. The method according to claim 1, wherein:
the haptic media comprises time-sequence haptic media that is encapsulated as a haptic media track in the media file;
the haptic media track comprises one or more samples that each comprises one or more haptic signals of the time-sequence haptic media;
the relationship indication information comprises a metadata track that is configured to indicate dependency information that the one or more samples in the haptic media track depend on during a presentation, and to indicate a dynamic temporal change of the dependency information;
the metadata track comprises one or more metadata samples respectively associated with the one or more samples in the haptic media track, the metadata track being associated with the haptic media track based on a track reference of a preset type; and
a metadata sample in the metadata track associated with a sample in the haptic media track comprises dependency information that the sample in the haptic media track depends on during a presentation, the metadata sample being aligned in time with the sample in the haptic media track.

8. The method according to claim 7, wherein:
the metadata track comprises a dependency information structure number field, a dependency information identification field, a dependency cancellation flag field, and a dependency information structure field for the metadata sample in the metadata track;
the dependency information structure number field is configured to indicate a number of pieces of dependency information in the metadata sample in the metadata track;
the dependency information identification field is configured to indicate an identifier of current dependency information that the sample in the haptic media track depends on during the presentation;
the dependency cancellation flag field is configured to indicate whether the current dependency information is valid; and
the dependency information structure field is configured to indicate content of the current dependency information.

9. The method according to claim 1, wherein:
the haptic media comprises non-time-sequence haptic media that is encapsulated as one or more haptic media items in the media file;
a haptic media item in the one or more haptic media items comprises one or more haptic signals of the non-time-sequence haptic media;
the relationship indication information comprises an entity group including one or more entities respectively corresponding to the haptic media item and one or more non-haptic media items of the non-haptic media, and the entity group indicating a dependency relationship between the haptic media item to the one or more non-haptic media items in the entity group;
the entity group comprises an entity group identification field, an entity number field, and an entity identification field;
the entity group identification field is configured to indicate an identifier of the entity group, and different entity groups have different identifiers;
the entity number field is configured to indicate a number of entities in the entity group; and
the entity identification field is configured to indicate entity identifiers of the haptic media item and the one or more non-haptic media items in the entity group, an entity identifier of an item in the entity group being an item identifier of the item, or a track identifier of a track for the item.

10. The method according to claim 9, wherein:
the haptic media item includes one or more dependency properties indicating dependency information that the haptic media item depends on during a presentation;
a dependency property in the one or more dependency properties comprises a dependency information structure number field and a dependency information structure field;
the dependency information structure number field is configured to indicate a number of pieces of dependency information that the haptic media item depends on during the presentation; and
the dependency information structure field is configured to indicate content of the dependency information that the haptic media item depends on during presentation.

11. The method according to claim 1, wherein:
the association relationship comprises a simultaneous presentation relationship that is indicated by a presentation dependency flag field in a dependency information structure field;
the presentation dependency flag field is configured to indicate whether a current haptic media resource of the haptic media is to be simultaneously presented with one or more non-haptic media resources that the current haptic media resource depends on during a presentation; and
in response to that the presentation dependency flag field indicates a simultaneous presentation, the dependency information structure field of the current haptic media resource comprises a simultaneous dependency flag field, a first preset value of the simultaneous dependency flag field indicating that the current haptic media resource simultaneously depends on a plurality of media types during the presentation, and a second preset value of the simultaneous dependency flag field indicating that the current haptic media resource depends, during the presentation, on any one of the plurality of media types.

12. The method according to claim 6, wherein:
the association relationship comprises a condition trigger relationship indicating a trigger condition;
the trigger condition comprises at least one of a particular object, a particular spatial region, a particular event, a particular viewing angle, a particular sphere region, or a particular viewport;
the dependency information structure field comprises an object dependency flag field, a spatial region dependency flag field, an event dependency flag field, a viewing angle dependency flag field, a sphere region dependency flag field, and a viewport dependency flag field;
the object dependency flag field is configured to indicate whether a current haptic media resource depends on a particular object in the non-haptic media during the presentation;
in response to that the object dependency flag field indicates that the current haptic media resource depends on a particular object in the non-haptic media during the presentation, the dependency information structure field further comprises an object identification field that is configured to indicate an identifier of the particular object;
the spatial region dependency flag field is configured to indicate whether the current haptic media resource depends on a particular spatial region in the non-haptic media during the presentation;
in response to that the spatial region dependency flag field indicates that the current haptic media resource depends on a particular spatial region in the non-haptic media during the presentation, the dependency information structure field further comprises a spatial region structure field for indicating information of the particular spatial region;
the event dependency flag field is configured to indicate whether the current haptic media resource depends on a particular event in the non-haptic media during the presentation;
in response to that the event dependency flag field indicates that the current haptic media resource is triggered by a particular event in the non-haptic media during the presentation, the dependency information structure field further comprises an event label field that is configured to indicate a label of the particular event;
the viewing angle dependency flag field is configured to indicate whether the current haptic media resource depends on a particular viewing angle during the presentation;
in response to that the viewing angle dependency flag field indicates that the current haptic media resource depends on a particular viewing angle during the presentation, the dependency information structure field further comprises a viewing angle identification field for indicating an identifier of the particular viewing angle;
the sphere region dependency flag field is configured to indicate whether the current haptic media resource depends on a particular sphere region during the presentation;
in response to that the sphere region dependency flag field indicates that the current haptic media resource depends on a particular sphere region during presentation, the dependency information structure field further comprises a sphere region structure field for indicating information of the particular sphere region;
the viewport dependency flag field is configured to indicate whether the current haptic media resource depends on a particular viewport during the presentation; and
in response to that the viewport dependency flag field indicates that the current haptic media resource depends on a particular viewport during presentation, the dependency information structure field further comprises a viewport identification field that is configured to indicate an identifier of the particular viewport.

13. The method according to claim 11, wherein:
the dependency information structure field comprises a media type number field and at least a media type field;
the media type number field is configured to indicate a number of types of media that the current haptic media resource simultaneously depends on during the presentation;
the media type field is configured to indicate a media type of the non-haptic media;
a first preset value of the media type field indicates two-dimensional video media;
a second preset value of the media type field indicates audio media;
a third preset value of the media type field indicates volumetric video media;
a fourth preset value of the media type field indicates multi-viewing-angle video media; and
a fifth preset value of the media type field indicates subtitle media.

14. The method according to claim 1, wherein the haptic media is streamed, and the obtaining the media file of a haptic media comprises:
obtaining transmission signaling of the haptic media, the transmission signaling including description information of the relationship indication information; and
obtaining the media file of the haptic media according to the transmission signaling.

15. The method according to claim 14, wherein:
the association relationship comprises a dependency relationship;
the description information comprises a preselected set that defines the haptic media and the non-haptic media;
the preselected set comprises an identifier list of a preselection component property;
the identifier list comprises a first adaption set corresponding to the haptic media and a second adaption set corresponding to the non-haptic media;
the preselected set further comprises a third adaption set corresponding to a metadata track in response to that the media file comprises the metadata track;
wherein:
each respective adaption set of the first adaption set, the second adaption set and the third adaption set has a media type element field that is configured to indicate a media type of media corresponding to the respective adaption set, the media type including at least one of a sample entry type of a track, a handler type of a track, a type of an item, or a handler type of an item.

16. The method according to claim 15, wherein:
the description information comprises a dependency information descriptor that defines dependency information of a haptic media resource of at least one of a representation level, an adaption set level, or a preselection level;
in response to that the dependency information descriptor defines dependency information of a haptic media resource of the adaption set level, haptic media resources of the representation level in the haptic media resource of the adaption set level share the dependency information;
in response to that the dependency information descriptor defines dependency information of a haptic media resource of the preselection level, haptic media resources of the representation level in the haptic media resource of the preselection level share the dependency information;
in response to that the dependency information descriptor exists in the transmission signaling and the preselected set does not comprise the metadata track, the dependency information descriptor is valid for each sample of the haptic media resource; and
in response to that the dependency information descriptor exists in the transmission signaling and the preselected set comprises the metadata track, the dependency information descriptor is valid for a portion of samples of the haptic media resource, and the portion of samples are determined based on metadata samples in the metadata track.

17. The method according to claim 1, wherein the decoding the bitstream comprises:
obtaining, based on the association relationship indicated by the relationship indication information, the non-haptic media associated with the haptic media;
decoding the haptic media and the non-haptic media; and
presenting the non-haptic media and the haptic media based on the association relationship; wherein:
the non-haptic media comprises at least one of: two-dimensional video media, audio media, volumetric video media, multi-viewing-angle video media, and/or subtitle media.

18. An information processing apparatus, comprising processing circuitry configured to:
obtain a media file of haptic media, the media file comprising a first portion that is a bitstream of media data of the haptic media and a second portion that is relationship indication information indicating an association relationship between the haptic media and at least a non-haptic media; and
decode the bitstream according to the relationship indication information to obtain the media data for presenting the haptic media.

19. The information processing apparatus according to claim 18, wherein the processing circuitry is configured to:
obtain, based on the association relationship indicated by the relationship indication information, the non-haptic media associated with the haptic media;
decode the haptic media and the non-haptic media; and
present the non-haptic media and the haptic media based on the association relationship; wherein:
the non-haptic media comprises at least one of: two-dimensional video media, audio media, volumetric video media, multi-viewing-angle video media, or subtitle media.

20. A non-transitory computer-readable storage medium storing instructions which when executed by at least one processor cause the at least one processor to perform:
obtaining a media file of haptic media, the media file comprising a first portion that is a bitstream of media data of the haptic media and a second portion that is relationship indication information indicating an association relationship between the haptic media and at least a non-haptic media; and
decoding the bitstream according to the relationship indication information to obtain the media data for presenting the haptic media.
